(19) United States
(12) Patent Application Publication
(10) Pub. No.: US 2022/0196849 A1
(43) Pub. Date: Jun. 23, 2022

(54) VEHICLE LOCALIZATION SYSTEMS AND METHODS

(71) Applicant: ClearMotion, Inc., Billerica, MA (US)

(72) Inventors: Allen Chung-Hao Chen, San Jose, CA (US); Yu Jiang, Wellesley, MA (US); Jack A. Ekchian, Belmont, MA (US); Marco Giovanardi, Melrose, MA (US)

(73) Assignee: ClearMotion, Inc., Billerica, MA (US)

(21) Appl. No.: 17/489,924

(22) Filed: Sep. 30, 2021

Related U.S. Application Data
(60) Provisional application No. 63/130,042, filed on Dec. 23, 2020.

(51) Int. Cl. G01S 19/42; G01S 19/51

(52) U.S. Cl. CPC G01S 19/423; G01S 19/51

(57) ABSTRACT

Methods and systems are described for establishing high-accuracy absolute landmarks that can be used to locate a vehicle's location during a vehicle/HAAL interaction event in some embodiments. Comparing that information with GNSS satellite data allows GNSS satellite errors to be determined and either used by a first vehicle and/or conveyed to other vehicles in the region in some embodiments. Methods and systems are also described for obtaining effectively continuous values of intermittently measured road surface parameters that are determined over time by discrete measurements by systems in a plurality of vehicles in some embodiments.

### CROSS-REFERENCE TO RELATED APPLICATIONS

This application claims the benefit under 35 U.S.C. § 119(e) of U.S. provisional application Ser. No. 63/130,042, filed Dec. 23, 2020, the disclosure of which is incorporated by reference herein in its entirety.

### FIELD

Disclosed embodiments are related to vehicle localization systems and methods.

### BACKGROUND

GNSS (Global Navigation Satellite System) based vehicle localization is becoming increasingly common. However, it is also generally recognized that current GNSS systems, including GPS, lack sufficient accuracy for some applications. Systems such as RTK (Real-Time Kinematic) positioning provide increased accuracy but are expensive and cumbersome as it uses individual stationary base stations that can only determine a localization error associated with the location of the base station for use by nearby GNSS systems.

### SUMMARY

According to one aspect, the disclosure provides a method for determining an absolute location of a feature associated with a segment of a road. The method may include interacting with the feature with a first vehicle; estimating the absolute location of the first vehicle during the interaction by using a first GNSS receiver on board the first vehicle; obtaining a first estimate of the absolute location of the feature based on the estimate of the absolute location of the vehicle; interacting with the feature with a second vehicle; estimating the absolute location of the second vehicle during the interaction with the second vehicle by using a second GNSS receiver on board the second vehicle; obtaining a second estimate of the absolute location of the feature based on the second estimate; averaging at least the first estimate and the second estimate; and determining the absolute location of the feature based on the average.

In one embodiment, a method of correcting a localization error of a vehicle traveling along a road segment includes: interacting with a landmark associated with the road segment with the vehicle; identifying the landmark; determining a Global Navigation Satellite System (GNSS) measurement of the location of the vehicle; and determining a GNSS localization error based at least in part on the location of the landmark and the GNSS location of the vehicle.

In another embodiment, a method for correcting a localization error of a first vehicle includes: receiving GNSS localization error from a second vehicle for a region where the first vehicle is located; determining a GNSS location of the first vehicle; and correcting the GNSS location of the first vehicle based at least party on the GNSS localization error.

In another embodiment, a method of determining an absolute location of a landmark associated with a road segment includes: obtaining a plurality of estimated locations of the landmark, wherein each estimated location of the landmark is based at least in part on an estimated location of a vehicle when the vehicle interacts with the landmark; and averaging at least a first portion of the plurality of estimated locations of the landmark to determine the absolute location of the landmark.

In another embodiment, a method of determining an absolute location of a feature associated with a road segment includes: (a) on multiple occasions, determining that each of a plurality of vehicles is located at the feature; (b) on each occasion in (a), determining an estimated absolute location of each of the multiplicity of vehicles by using an onboard GNSS receiver; and (c) determining the absolute location of the feature based at least partially on an average of at least a subset of the estimated absolute locations determined in (b).

In another embodiment, a method of measuring a road surface property includes: while a first vehicle is travelling along a road segment, intermittently measuring the road surface property at one or more discrete positions along the road segment; determining a location associated with each intermittent measurement of the road surface property, wherein the location information is based at least in part on a location of the vehicle and dead-reckoning; associating each intermittent measurement of the road surface property with the corresponding determined location.

In another embodiment, a method of determining a spatial distribution a road surface property on a surface of a road segment includes: obtaining a plurality of intermittent discrete measurements of the road surface property associated with separate discrete locations on the road surface from a plurality of vehicles; and aggregating the plurality of intermittent measurements and the associated discrete locations to provide a spatial distribution of the road surface property on the surface of the road segment.

According to another aspect, the present disclosure provides a method of determining an absolute location of a first feature associated with a segment of a road. The method may include interacting with the first feature with a plurality of vehicles; estimating the absolute location of each of the plurality of vehicles when each of the plurality of vehicles interacts with the first feature by using a GNSS receiver on board each of the plurality of vehicles; obtaining a plurality of estimates of the absolute location of the first feature, wherein each estimate of the absolute location of the first feature corresponds to one estimate of the absolute location of each of the plurality of vehicles at the time of interaction with the first feature; averaging at least some of the plurality of estimates; and determining the absolute location of the first feature based on the averaging of at least some of the plurality of estimates.

In some implementations of the disclosed method, the first feature may include a specific pattern of road surface content. In some implementations, plurality of vehicles may range from 5 vehicles to one million vehicles or more. In some implementations, estimating an absolute location of a vehicle may involve determining the location of the vehicle to within 15 meters or within 5 meters of the actual location of the vehicle by using GNSS, or determining the location of the vehicle to within 1 m or less by using enhanced GNSS (e.g., RTK (Real Time Kinematic GPS) and/or additional sensors such as inertial measurement units, vision-based sensors such as cameras, or range-based sensors such as Radar or LiDAR. In some implementations, averaging of the GNSS based estimates may involve computing or determining the mean, the median, or the mode of the estimates. In some implementations all of the plurality of the estimates may be included in the averaging process, while in other implementations, estimates, based on data previously identified as poor quality data, may not be included altogether or given lower weighting. In some implementations, a weighted averaging process may be used to more heavily weight some estimates than others based for example on the expected, estimated, or perceived quality of each estimate. In some implementations GNSS receivers may include one or more GPS, BeiDou/BDS, Galileo, GLONASS, IRNSS/NavIC (India) and/or QZSS receivers. In some implementations, the process of estimating the absolute location of the first feature may involve accounting for the magnitude and direction of the offset between the antenna of a vehicle's GNSS receiver and the portion of the vehicle that interacts with the first feature. According to another aspect, the present disclosure provides a method of determining an absolute location of at least a portion of a vehicle. The method may include travelling along a segment of a road with a first vehicle; interacting with a landmark associated with the segment; obtaining information about an absolute location of the landmark from a data base; and, based on the information, determining a first absolute location of at least the portion of the first vehicle that interacts with the landmark.

In some implementations the disclosed method may also include receiving data from multiple GNSS satellites with a receiver on board the first vehicle; based on the data, determining a second absolute location of at least the portion of the first vehicle; and based on the first absolute location of a portion of the vehicle and the second absolute location, determining an error in the received GNSS data. The portion of the vehicle located by GNSS may be the antenna of the onboard GNSS receiver. In some implementations, the determined error may be a difference in the geocoordinates of the first absolute location and the second absolute location. In some implementations, the determined error may be associated with satellite, a group of satellites, or a region. Such errors may be determined by, e.g., satellite timing errors and/or satellite distance errors. In some implementations the GNSS satellites may be GPS, BeiDou/BDS, Galileo, GLONASS, IRNSS/NavIC and/or QZSS satellites. In some implementations the portion of the vehicle, that interacts with the landmark, may be the contact patch of a tire.

According to another aspect, the present disclosure provides a method of correcting localization errors of a vehicle, that is traveling along a segment of a road, with an onboard GNSS receiver. The method may include using one or more onboard sensors to determine that the vehicle has begun to interact or is interacting with a road surface feature of the road segment; accessing a database to obtain a previously determined absolute location of the road surface feature; determining a first absolute location of a portion of the vehicle based on the previously determined absolute location of the road surface feature and the relative location of the portion of the vehicle and the road surface feature during the interaction; using the GNSS receiver to determine a second absolute location of the portion of the vehicle; comparing the second absolute location to the first absolute position; and determining a GNSS localization error based on the difference between the first and second absolute positions.

In some implementations of the method, the portion of the vehicle that is located by using GNSS may be an antenna of the GNSS receiver of the vehicle. In some implementations the portion of the vehicle that interacts with the road surface feature may be the contact patch of a tire. In some implementations the portion of the vehicle that interacts with the road surface feature may be a non-contact sensor such as a radar or LiDAR sensor. In some implementations the GNSS localization error may be used by the vehicle itself and/or conveyed to at least one other vehicle.

According to another aspect, the present disclosure provides a method of correcting a localization error of a vehicle. The method may include detecting an interaction with a road surface feature; collecting information about the road surface feature with at least one onboard sensor; identifying the road surface feature based on the information collected; accessing information, about an absolute location of the road surface feature, from a data base; determining a first absolute location of a portion of the vehicle, based on the absolute location information accessed from the database; receiving signals from multiple GNSS satellites with an onboard GNSS receiver that includes an antenna; determining a second absolute location of the portion of the vehicle, based on the GNSS signals; and based on the first and second absolute locations determining a GNSS localization error.

In some implementations of the method, the portion of the vehicle may be the antenna of the onboard GNSS receiver. In some implementations, the GNSS localization error may be used by the vehicle and/or conveyed to at least one other vehicle.

According to another aspect, the present disclosure provides a method of correcting a localization error of a first vehicle. The method may include receiving GNSS localization error, for a region where the first vehicle is located, from a second vehicle; receiving GNSS signals from multiple satellites with a GNSS receiver on board the first vehicle based on the signals received by the a GNSS receiver in the first vehicle; determining an estimate of the location of the first vehicle based on the GNSS signals received by the first vehicle; and improving the estimate based on the error information received from the second vehicle.

According to another aspect, the present disclosure provides a method of determining a location of a detectable anomaly associated with a road segment. The method may include collecting information about at least one aspect of the anomaly with a first set of one or more sensors on board the first vehicle, while the first vehicle is travelling on the road segment; determining a first estimate of the location of the anomaly with a first GNSS receiver in the first vehicle during the collection of information with the first set of one or more sensors, wherein the first estimate of the location of the anomaly includes at least a first estimate of longitude and a first estimate of latitude of the anomaly; collecting information about the at least one aspect of the anomaly with a second set of one or more sensors in the second vehicle, while the second vehicle is travelling on the road segment; determining a second estimate of the location of the anomaly with a second GNSS receiver in the second vehicle during the collection of information with the second set of one or more sensors, wherein the second estimate of the location of the anomaly includes at least a second estimate of longitude and a second estimate of latitude of the anomaly; and determining the location of the detectable anomaly by computing the longitude of the anomaly based at least on the first estimate of longitude and the second estimate of longitude and computing the latitude of the anomaly based on the first estimate of latitude and the second estimate of latitude.

In some implementations of the method, the detectable anomaly may be a road surface irregularity, a subterranean irregularity, or an observable roadside feature. In some implementations of the method, the first and second sensors may be an accelerometer, a displacement sensor, an inertial measurement unit (IMU), a camera, a range sensor, and/or an x-ray detector. In some implementations of the method, the subterranean irregularity may be a pipe, or a rock. In some implementations of the method, road surface irregularity may be, for example, a pothole, a bump, a surface crack, an expansion joint, a frost heave, a rough patch, a rumble strip, or a storm grate. In some implementations of the method, the road surface feature may be a recognizable pattern or signature of road content, e.g., detected or measured by an on-board sensor.

According to another aspect, the present disclosure provides a method of determining the location where at least one discrete road surface parameter measurement is obtained. The method may include measuring at least one discrete road surface parameter at a first location along a road segment, while a first vehicle is travelling along the road segment; and associating the measurement with absolute location information at the first vehicle position, wherein the absolute location information is based on GNSS data obtained at a second vehicle position along the road segment and dead reckoning between the two vehicle positions.

In some implementations of the method, the first vehicle may reach the first location before it reaches the second position. Alternatively, in some implementations the first vehicle may reach the second location before it reaches the first position. In some implementations of the method, the surface parameter may be, for example, friction coefficient, traction and road-grip. In some implementations of the method may include making multiple discrete road surface parameter measurements along the road segment with a single vehicle or multiple vehicles.

According to another aspect, the present disclosure provides a method of determining the spatial distribution of the value of a road surface parameter on a road segment. The method may include collecting a first set of discrete road surface parameter measurements, while a first vehicle is travelling on the road surface; associating each of the parameter measurements with the absolute location where the measurements were obtained; storing the measurements and the associated location information in a data base; collecting a second set of discrete road surface parameter measurements, while a second vehicle is travelling on the road surface; associating each of the measurements in the second set with the absolute location where the measurements were obtained; storing the measurements and the associated location information in the data base.

In some implementations of the method, the method includes collecting additional sets of discrete road surface parameter measurements with a plurality of additional vehicles, while each of a plurality of additional vehicles is travelling on the road surface; associating each of the measurements with the absolute location where the measurement was obtained; and storing the measurements and the associated location information in the data base; where the distribution of discrete measurements provides an effectively continuous spatial distribution of road surface parameters on the road-segment.

In another embodiment, a method of determining an absolute location of a feature associated with a segment of a road includes: (a) interacting with the feature with a first vehicle; (b) estimating the absolute location of the first vehicle during step (a) by using a first GNSS receiver on board the first vehicle; (c) obtaining a first estimate of the absolute location of the feature based on the estimate in (b); (d) interacting with the feature with a second vehicle; (e) estimating the absolute location of the second vehicle during step (d) by using a second GNSS receiver on board the second vehicle; (f) obtaining a second estimate of the absolute location of the feature based on the estimate in (e); (g) averaging at least the first estimate from step (c) with the second estimate from step (f); and (h) determining the absolute location of the feature based at least on the average obtained in (g).

In another embodiment, a method of determining an absolute location of a first feature associated with a segment of a road, the method comprising: (a) interacting with the first feature with a multiplicity of vehicles; (b) estimating the absolute location of each of the multiplicity of vehicles when each of the multiplicity of vehicles interacts with the first feature by using a GNSS receiver on board each of the multiplicity of vehicles; (c) obtaining a multiplicity of estimates of the absolute location of the first feature, wherein each estimate of the absolute location of the first feature corresponds to one estimate of the absolute location of each of the multiplicity of vehicles in (b); (d) averaging at least some of the multiplicity of estimates obtained in (c); and (e) determining the absolute location of the first feature based on the average obtained in (d).

In the above embodiments, the first feature may be a roadside feature.

In the above embodiments, the roadside feature may be selected from a group consisting of a bridge, a building, a tree, and a road sign.

In the above embodiments, the first feature may be a detectable sub-terranean anomaly.

In the above embodiments, the detectable sub-terranean anomaly may selected from a group consisting of a buried pipe and a boulder.

In the above embodiments, the first feature may be a road-surface feature.

In the above embodiments, the road-surface feature may be selected from a group consisting of a pothole, a bump, a surface crack, an expansion joint, and a frost heave.

In the above embodiments, the multiplicity of vehicles may include less than one million vehicles but more than 10 vehicles.

In the above embodiments, the absolute location of each of the multiplicity of vehicles may be determined to within 15 meters of the actual location of the vehicle by using GNSS.

In the above embodiments, averaging may include computing a quantity selected from a group consisting of a mean, a median, and a mode.

In the above embodiments, all of the multiplicity of the obtained estimates may be included in the averaging.

In the above embodiments, the methods may also include determining that at least one of the multiplicity of estimates is from a vehicle previously identified as providing faulty data. The at least one of the multiplicity of estimates may not be included in the averaging.

In the above embodiments, the GNSS receiver may be a GPS receiver.

In the above embodiments, obtaining a multiplicity of estimates of the absolute location of the first feature may include accounting for the distance between an antenna of the GNSS receiver and a portion of each of the multiplicity of vehicles that interact with the first feature.

In another embodiment, a method of determining an absolute location of at least a portion of a vehicle includes: (a) travelling along a segment of a road with a first vehicle; (b) interacting with a landmark associated with the segment in (a); (c) obtaining information about an absolute location of the landmark in (b), from a data base; and (d) based on the information in (c), determining a first absolute location of at least a portion of the first vehicle.

In the above embodiment, the method may also include: (e) with a GNSS receiver on board the first vehicle, receiving data from multiple GNSS satellites; (f) based on the data in (e), determining a second absolute location of at least the portion of the first vehicle; and (g) based on the first absolute location in (d) and the second absolute location in (f), determining an error in the GNSS data received in (e).

In the above embodiment, the error determined in (f) is a difference in the geocoordinates of the first absolute location and the second absolute location.

In the above embodiment, the error determined in (f) is an error specific to one of the multiple satellites in (e).

In the above embodiment, the error specific to one of the multiple satellites is selected from the group consisting of a satellite timing error and a satellite distance error.

In the above embodiments, the GNSS satellites are GPS satellites.

In the above embodiments, the portion of the vehicle is the contact patch of a tire that interacts with the landmark.

In another embodiment, a method of correcting a localization error of a vehicle, with a GNSS receiver, traveling along a segment of a road includes: (a) with onboard sensors, determining that the vehicle has begun to interact with a road-surface feature of the road segment; (b) accessing a database to obtain an absolute position of the road-surface feature in (a); (c) determining a first absolute position of a portion of the vehicle based on the relative position of the portion of the vehicle and the road surface feature in (a); (d) using the GNSS receiver to determine a second absolute position of the portion of the vehicle; (e) comparing the second absolute position to the first absolute position; and (f) determining a GNSS localization error based on the difference between the first and second absolute positions.

In the above embodiments, the portion of the vehicle is an antenna of the GNSS receiver.

In the above embodiments, the portion of the vehicle is a contact patch of a tire that interacts with the road-surface feature.

In the above embodiments, the GNSS localization error is conveyed to at least one other vehicle.

In another embodiment, a method of correcting a localization error of a vehicle includes: (a) detecting an interaction with a road-surface feature; (b) collecting information about the road-surface feature with at least one onboard sensor; (c) identifying the road-surface based on the information collected in (b); (d) accessing information about an absolute location the road-surface feature from a data base; (e) based on the absolute location information accessed in (d), determining a first absolute location of a portion of the vehicle; (f) receiving signals from multiple GNSS satellites with an onboard GNSS receiver that includes an antenna; (g) based on the signals in (f), determining a second absolute location of the portion of the vehicle; and (h) based on the first and second absolute locations determining a GNSS localization error.

In the above embodiments, the portion of the vehicle is the antenna of the GNSS receiver.

In the above embodiments, the GNSS localization error is conveyed to at least one other vehicle.

In another embodiment, a method correcting a localization error of a first vehicle includes: (a) receiving GNSS localization error information from a second vehicle for a region where the first vehicle is located; (b) receiving GNSS signals from multiple satellites with a GNSS receiver on board the first vehicle; (c) based on the signals received in (b), determining an estimate of the location of the first vehicle; (d) based on the error information received in (a), improving the estimate determined in (c).

In another embodiment, a method of determining a location of a detectable anomaly associated with a road segment includes: (a) while a first vehicle is travelling on the road segment, collecting information about at least one aspect of the anomaly with a first set of at least one or more sensors on board the first vehicle; (b) during the collection of information in (a), determining a first estimate of the location of the anomaly with a first GNSS receiver in the first vehicle, wherein the first estimate of the location of the anomaly includes at least a first estimate of longitude and a first estimate of latitude of the anomaly; (c) while a second vehicle is travelling on the road segment, collecting information about the at least one aspect of the anomaly with a second set of at least one or more sensors in the second vehicle; (d) during the collection of information in (c), determining a second estimate of the location of the anomaly with a second GNSS receiver in the second vehicle, wherein the second estimate of the location of the anomaly includes at least a second estimate of longitude and a second estimate of latitude of the anomaly; and (e) determining the location of the detectable anomaly by computing the longitude of the anomaly based at least on the first estimate of longitude and the second estimate of longitude and computing the latitude of the anomaly based on the first estimate of latitude and the second estimate of latitude.

In the above embodiments, the detectable anomaly is selected from the group consisting of a road surface irregularity, a subterranean irregularity, and an observable road side feature.

In the above embodiments, the first and second set of sensors are selected from the group consisting of an accelerometer, a displacement sensor, an IMU, a camera, and an x-ray detector.

In the above embodiments, the subterranean irregularity is selected from the group consisting of a pipe, and a rock.

In the above embodiments, the road surface irregularity is selected from the group consisting of a pothole, a bump, a crack, a rough patch, and a storm grate.

In another embodiment, a method of determining the location of at least one discrete road-surface parameter measurement includes: (a) while a first vehicle is travelling along a road segment, measuring at least one discrete road-surface parameter at a first position along the road segment; and (b) associating the measurement in (a) with absolute location information at the first position, wherein the absolute location information is based on GNSS data obtained at a second position along the road segment and dead-reckoning between the two positions.

In the above embodiments, the first vehicle reaches the first position before it reaches the second position.

In the above embodiments, the first vehicle reaches the second position before it reaches the first position.

In the above embodiments, the surface parameter is selected from the group consisting of friction coefficient, traction, and road-grip.

In the above embodiments, the method may include making multiple discrete road-surface parameter measurements along the road segment.

In another embodiment, a method of determining a spatial distribution of a value of a road-surface parameter on the surface of a road segment includes: (a) while a first vehicle is travelling on the road surface, collecting a first set of discrete road-surface parameter measurements; (b) associating each of the measurements in (a) with the absolute location where the measurement was obtained; (c) storing the measurements and the associated location information in a data base; (d) while a second vehicle is travelling on the road surface, collecting a second set of discrete road-surface parameter measurements; (e) associating each of the measurements in (d) with the absolute location where the measurement was obtained; (f) storing the measurements and the associated location information in step (e) in the data base.

In the above embodiments, the method may include: (g) while each of a multiplicity of additional vehicles is travelling on the road surface, collecting additional sets of discrete road-surface parameter measurements; associating each of the measurements in the additional sets with the absolute location where each measurement was obtained; and (i) storing the measurements and the associated location information in the data base; wherein the distribution of discrete measurements provides an effectively continuous spatial distribution of road-surface parameter of the road-surface parameter on the road-segment.

It should be appreciated that the foregoing concepts, and additional concepts discussed below, may be arranged in any suitable combination, as the present disclosure is not limited in this respect. Further, other advantages and novel aspects of the present disclosure will become apparent from the following detailed description of various nonlimiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not necessarily intended to be drawn to scale. In the drawings, each identical or nearly identical component that is illustrated in the various figures may be represented by a like numeral. For purposes of clarity, not every component may be labeled in every drawing. In the drawings:

FIG. 1 illustrates four GNSS satellites transmitting signals that are received by a GNSS receiver on board a vehicle;

FIG. 2 illustrates the intersection, on the surface of the Earth, of three spheres centered on three GNSS satellites;

FIG. 3 illustrates examples of local factors which may interfere with or disrupt signals from multiple GNSS satellites received at a GNSS receiver in a vehicle;

FIG. 4 illustrates the actual location of an exemplary GNSS receiver as well as the variation over time of measurements of longitude and latitude measured by the receiver;

FIG. 5 illustrates the longitude and latitude of a vehicle, as determined by a GNSS receiver on board the vehicle, as well as the region of uncertainty centered around the measured location where the vehicle may by located with a certain probability;

FIG. 6 illustrates a top view of an exemplary vehicle traveling along an exemplary road segment and three examples of road surface features, two examples of road-side features, and an example of a subterranean feature;

FIG. 7 illustrates a left-front tire of a vehicle interacting with the pothole of the road segment shown in FIG. 6;

FIG. 8 illustrates the right front tire of an exemplary vehicle undergoing contact-interaction with the pothole shown in FIGS. 6 and 7;

FIG. 9 illustrates an exemplary vehicle travelling along the road segment shown in FIGS. 6-8 where the front tires of vehicle straddle the pothole;

FIG. 10 illustrates an exemplary vehicle undergoing contact-interaction with another road surface feature associated with the road segment shown in FIG. 6;

FIG. 11 illustrates an exemplary vehicle receiving GNSS signals from several satellites while approaching an exemplary, previously-established HAAL,

FIG. 12 shows the vehicle of FIG. 11 interacting with the HAAL of FIG. 11;

FIG. 13 illustrates the vehicle of FIG. 11 receiving signals from GNSS satellites while interacting with the HAAL, acting as a source vehicle by conveying information about GNSS errors to a network, and a second vehicle acting as a consumer vehicle by receiving information from the network;

FIG. 14 illustrates an exemplary cloud-based network that receives GNSS error data from source vehicles and conveys error related information to consumer vehicles;

FIG. 15 illustrates the vehicle of FIG. 13 receiving GNSS satellite information, while at some distance from the HAAL, and providing error related information that may be used by the network or other vehicles;

FIG. 16 illustrates locations on the surface of a road segment where discrete measurements have been made of a road surface related parameter by an exemplary vehicle;

FIG. 17 illustrates locations on the surface of the road segment of FIG. 16 where additional discrete measurements have been made of the road surface related parameter by a second exemplary vehicle;

FIG. 18A is one embodiment of a method for determining an absolute location of a landmark associated with a road segment;

FIG. 18B is one embodiment of a method for determining an estimated location of a landmark associated with a road segment;

FIG. 19 is one embodiment of a method for determining an error associated with a measured Global Navigation Satellite System location from a Global Navigation Satellite System; and

FIG. 20 is one embodiment of a method for aggregating intermittently measured road surface parameters associated with a road surface.

### DETAILED DESCRIPTION

A motor vehicle traveling along a road, autonomously or under the control of a driver, may interact with one or more road surface features that may expose the vehicle and/or one or more vehicle occupants to certain forces or accelerations. Such forces or accelerations may affect the comfort, safety, and/or wellbeing of vehicle occupants as well as wear-and-tear of the vehicle. The magnitude, direction, and/or frequency content of such forces or accelerations may be a function of the characteristics of one or more road surface features. A section of a road surface may also have certain properties, including but not limited to road surface texture, road surface composition, surface camber, surface slope, etc. Such road surface properties may affect road surface parameters, such as for example, the friction coefficient between the tires of a vehicle and the road, traction and/or road-grip. Such parameters may determine how effectively certain maneuvers, such as turning and stopping, may be performed at various speeds and vehicle loading.

In some embodiments, one or more systems of a vehicle may be operated based on information about the location of the above-noted road surface features and their characteristics and/or surface properties of sections of the road to be traversed. However, the types and characteristics of road surface features may vary, for example, from road to road, as a function of longitudinal and/or lateral location on a given road. The effect of vehicle interaction with a given road surface feature, on the vehicle and/or an occupant, may also vary as a function of vehicle speed at the time of the interaction between the vehicle and the particular road surface feature. The characteristics of a road surface feature may also vary, for example, based on weather conditions, and/or as a function of time. For example, if the road surface feature is a pothole, it may gradually appear and grow, in length, width, and/or depth, over the winter months because of repeated freeze/thaw cycles, and then be repaired in a matter of hours or less and effectively disappear. In some embodiments, if the surface features of a road are uncharacterized and/or if the location of such features is unknown, operation of a vehicle traveling along the road may depend on reacting to sensed interactions between the vehicle and the road surface. Various automatic and/or semi-automatic systems of the vehicle may react to the detected interaction between the road surface features the vehicle encounters. In some embodiments, if the surface features of a road are characterized and their location relative to the vehicle is known, interactions between the vehicle and a surface feature may be anticipated. If the vehicle's location relative to the surface features of the road, as well as the absolute locations of the surface features on the road, are sufficiently well known prior to the vehicle encountering the road surface features, the vehicle may prepare a response to the anticipated interaction before the interaction commences.

As noted above, characteristics and road surface features of a road surface that a vehicle may encounter may be mapped to provide a priori information about the road surface features located along a path of travel of a vehicle. This a priori information about road surface features ahead of the vehicle may be used to, for example, dynamically tune, prepare, and/or control various automated or partially automated systems in the vehicle (such as for example, suspension systems (semi- or fully active), propulsion systems, adaptive driver assistance systems (ADAS); electric power steering systems (EPS); antilock braking systems (ABS), etc.). Typically, when there is a physical interaction between a vehicle and a road surface feature, the vehicle may be exposed to one or more perceptible forces that are induced by the interaction. Thus, with a preview of the road ahead, a vehicle controller or a driver may make decisions ranging from what roads to take and/or how to more effectively react to road surface features when there is a physical interaction between the vehicle and the road surface feature.

While a priori information about a road surface may be useful for the control of various systems of a vehicle, there are challenges to doing so. One such challenge is knowing, with sufficient precision, the dimensions or scale (e.g., length, width, etc.) associated with one or more road surface features and/or their locations relative to a vehicle. Additionally, controllable systems in a vehicle may be associated with physical response times, such as limitations on how quickly each such system may be able to respond to new information about an approaching road surface feature. Thus, a priori information about an upcoming road surface feature may be used effectively, or more effectively, by one or more controllers in a vehicle if a distance between the location of the road surface feature and the current location of the vehicle, or a portion of that vehicle, is known sufficiently in advance and with sufficient precision/accuracy.

For example, if an upcoming road surface feature happens to be a pothole, in some embodiments, it may not be adequate to provide information to a controller of a vehicle system that there is a pothole ahead of the vehicle. In some embodiments, the particular geometry of the pothole (e.g., depth, width, and length) ahead of the vehicle may be provided to one or more controllers on-board the vehicle. Additionally, in some embodiments, the performance of one or more such vehicle systems may depend on the accuracy of the information about the road surface feature (e.g., the depth, width, and/or length of a pothole) as well as an accuracy of the known location of a vehicle relative to the road surface feature on the road surface, which may be used to inform the system(s) as to whether, for example, the left-side tire(s), right-side tire(s), or other portion of the vehicle is expected to interact with the road surface feature. To enable a system controller to anticipate an interaction with a road surface feature (e.g., the pothole), and to appropriately prepare for and react to the interaction, information about dimensions of the road surface feature, the location of the road surface feature relative to the vehicle or a portion of the vehicle that will interact with the road surface feature, and/or other information relating to the feature may be provided to at least one controller on-board the vehicle in advance of when the vehicle comes in contact with or otherwise traverses the road surface feature. By providing this information such an amount of time in advance, the vehicle system(s) may be able to respond appropriately or otherwise prepare to traverse the feature.

Such functionality may benefit or depend on accurate or precise information on a location of a vehicle, or a portion of a vehicle, relative to the location of a given road surface feature located on a road ahead. However, conventional approaches are limited in their ability to accurately locate the vehicle and/or to provide up to date accurate information about a road surface. For example, GNSS (Global Navigation Satellite System) systems may provide estimates of a vehicle's absolute location (e.g. latitude, longitude, and altitude) with an accuracy on the order of 5 m to 15 m depending on the local conditions and systems being used. Without wishing to be bound by theory, this may be due to certain errors or inaccuracies present in the GNSS system as elaborated on further below. Additionally, current systems that may be used to reduce this error are typically depend on stationary base stations where a GNSS error is determined at a known location and broadcast to vehicles traveling through the surrounding area. However, such a system is typically limited to the vicinity of the base station and costly to implement.

The above-noted inaccuracies associated with a measured GNSS absolute location of a vehicle, limit the ability to control the various systems of a vehicle based on this estimated location. For example, multiple road surface features of interest for controlling one or more systems of a vehicle (e.g., potholes) may have dimensions less than the currently-available accuracy of 5 m to 15 m for a measured GNSS locations. As such, the current accuracy of typical GNSS locations cannot reliably provide the vehicle's location with sufficient accuracy to permit control of the vehicle's systems on a length scale corresponding to the length scale of interest for road surface features that may be found on a road for controlling the one or more vehicle systems. To illustrate this difficulty, an example is provided relative to a pothole located on a two-lane road with directions of travel oriented in opposing directions. In such an arrangement, knowing a vehicle's location and/or a pothole's location within 5 m to 15 m of its actual location is not a usable accuracy for determining whether or not a vehicle will encounter the pothole on a road segment that may have a width that is on the order of about 10 m wide. Thus, such an estimated location may not be used reliably to determine when, or even if, a vehicle will encounter the pothole, or other road surface feature located on the road segment. Of course, while this example illustrates the difficulties associated with determining the location of a vehicle relative to a pothole or other road surface feature, it should be understood that other road surface features, as well as other length scales of interest, may be used in the various embodiments disclosed herein as the disclosure is not so limited.

In addition to the above, another localization system that may be used to locate a vehicle on a road surface is a Relative Localization System (RLS), (e.g., a terrain-based localization system or an optical road preview system) that may be used to determine the location of a vehicle, or a portion of a vehicle, relative to one or more landmarks on a road surface. An RLS landmark may be, for example, a road surface feature, or other feature associated with a road, that produces a sufficiently distinctive output from one or more sensors on board a vehicle (i.e. a unique profile of one or more sensed parameters) during an interaction with the landmark that may be identified using one or more microprocessors on-board the vehicle and/or in the cloud. However, RLS systems may identify an absolute known location of a vehicle at the time when the vehicle is interacting with the known landmark and an accuracy of the vehicle's location becomes less certain as a distance to the last identified landmark increases. Additionally, as noted above, a road surface may change due to weathering, repairs, damage, and other factors such that previously identified and located landmarks may change and/or disappear over time which may render such a localization system less accurate over time if such changes are not accounted for.

In view of the above, the Inventors have further recognized that it may be desirable to provide more accurate information related to the location of a vehicle on a road surface without being tied to static structure that is unable to adapt to changing factors on a road. Thus, the Inventors have recognized the benefits associated with a method for correcting a localization error of a vehicle where a known absolute location of a landmark identified by a vehicle in conjunction with the estimated GNSS location of the vehicle may be used to determine a GNSS localization error. This GNSS localization error may then be used to correct the GNSS location of the vehicle to provide a more accurate estimate of a vehicle's location on a road surface. Additionally, in some embodiments, this GNSS localization error may be updated whenever the vehicle encounters a new landmark on a road surface enabling the GNSS localization error to be determined and updated at any number of different locations without being tied to a specific limited geographical area. Additionally, GNSS errors determined by such a method may be transmitted to other vehicles wirelessly and/or over a network, e.g., the cloud.

In one embodiment, a method of correcting a localization error of a vehicle traveling along a road segment may include interacting with a landmark associated with the road segment with the vehicle. As elaborated on below, this interaction may include interactions where a vehicle physically interacts with a landmark present on a road-surface as well as non-contact interactions with the landmark (i.e., non-contact sensing) with e.g., road surface features, roadside features, or subsurface features. Regardless of the specific type of interaction, the vehicle may identify the landmark, and an absolute location of the landmark may be determined using information from an appropriate database that is either stored onboard the vehicle, buffered onto the vehicle, and/or is located on a remotely located server, e.g., in the cloud. For instance, in some embodiments, the vehicle may use a localization system, such as a Relative Localization System (RLS), to identify and determine a location of the landmark on the road surface. The vehicle may then determine a Global Navigation Satellite System (GNSS) estimated absolute location of the vehicle. Using this information, a GNSS localization error may then be determined based at least in part on the absolute location of the landmark and the measured GNSS location of the vehicle.

It is not always certain that a vehicle will be traveling on a road segment including a road surface that has been appropriately mapped to enable the localization of landmarks on the road surface. Additionally, in some instances, a distance between landmarks on, or otherwise associated with, a road surface and/or the availability of corresponding GNSS signals and/or locations associated with those landmarks may not permit the above method to be implemented with a desired degree of accuracy. Accordingly, in some embodiments, it may be desirable to use and/or transmit a previously determined GNSS localization error from one vehicle to one or more other vehicles in a surrounding area which may either be on the same road segment or different unrelated road segments in a surrounding area. In one such embodiment, a method for correcting a localization error of a first vehicle may include receiving a GNSS localization error that is transmitted from another vehicle in the region that the first vehicle is located. The transmission of the GNSS localization error from the second vehicle to the first vehicle may either be a direct transmission between the vehicles and/or the second vehicle may transmit the GNSS localization error to a remotely located database, e.g., a cloud server, that then re-transmits the GNSS localization error to the first vehicle. In either case, regardless of how the GNSS localization error is provided, the received GNSS localization error may be used to correct a measured GNSS location of the first vehicle.

Depending on the particular embodiment, a GNSS localization error may correspond to any number of appropriate parameters. For example, in one embodiment, the GNSS localization error may correspond to an absolute location offset and correcting the measured GNSS location may correspond to combining the absolute location offset with the measured GNSS location. Additionally, in another embodiment, the GNSS localization error may correspond to determined timing and/or distance errors associated with the GNSS signals received from one or more satellites the GNSS system is in communication with. In such an embodiment, correcting the GNSS location may correspond to correcting the timing and/or distance errors in the one or more received GNSS signals. Accordingly, it should be understood that a GNSS localization error may correspond to any parameter that may be used to correct the measured GNSS location of a vehicle to have an improved accuracy.

As noted above, to appropriately control the various systems of a vehicle using a priori information about a road surface feature along the path of travel of a vehicle, it may be desirable to have up-to-date information related to that road surface feature. This may either include the initial identification and mapping of a landmark associated with the road surface and/or updating of the location, size, and/or type of a road surface feature, e.g. a landmark, over time. This may include examples such as: a pothole that may slowly grow over time prior to being filled; a newly formed bump in a road surface following road work activity; seasonal changes in a road surface (e.g. frost heave); and/or any other number of different road surface features that may either be initially mapped and/or may change over time.

In view of the above, the Inventors have recognized the benefits associated with a method of determining an absolute location of one or more landmarks associated with a road segment. This may include obtaining a plurality of estimated absolute locations of the landmark from multiple sources, e.g., vehicles. Depending on the particular embodiment, the estimated absolute locations of the landmark may be based on an estimated absolute location of a vehicle when the vehicle identifies the landmark. In some embodiments, the landmark may be identified by the vehicle using an appropriate localization system that identifies the landmark using previously recorded information related to the landmark. For example, as detailed above, a localization system, such as a Relative Localization System (RLS), may be used to identify the landmark as the vehicle traverses a road segment. When the landmark is identified by the vehicle, the estimated absolute vehicle location when the vehicle interacts with the landmark may be used to determine an estimated absolute location of the landmark. Depending on the embodiment, the estimated absolute location of the vehicle may correspond to any appropriate type of location measurement including, but not limited to, a measured GNSS location of the vehicle, a location determined using an RLS system relative to another landmark combined with dead reckoning between the landmarks; a corrected GNSS location of the vehicle as disclosed herein; and/or any other appropriate type of localization method. Regardless of the specific type of estimated absolute vehicle location, the location of the vehicle may be used to determine an approximate absolute location of the landmark on the road surface. Depending on the embodiment, the vehicle location may be assumed to be the same as the location of the landmark. However, in some embodiments, an offset between the landmark and a portion of the vehicle may be used to determine the location of the landmark more precisely, as elaborated on further below. In either case, at least a subset of the plurality of estimated absolute locations of the landmark may be averaged to determine an absolute location of the landmark on the road surface of the road segment.

The accuracies in a measured location of a landmark or road feature, the corrected GNSS location of a vehicle, and/or a distance between a vehicle and an upcoming road surface feature may correspond to any desired level of accuracy for a given application. For example, certain applications may need higher accuracy location information than other applications. Accordingly, in some embodiments, an accuracy of the various locations determined using the methods described herein may be accurate within a distance that is less than or equal to 2.0 m, 1.0 m, 0.5 m, 0.01 m, 0.005 m and/or any other appropriate distance. The determined locations may also be accurate within a distance that is greater than or equal to 0.005 m, 0.01 m, 0.5 m, 1 m, and/or any other appropriate distance. Combinations of the foregoing ranges are contemplated including, for example, a determined location may be accurate to within a distance that is between or equal to 0.005 m and 2.0 m, 0.005 m and 1.0 m, 0.01 m and 1.0 m, 0.1 m and 2.0 m, 0.01 m and 5.0 m. Of course, accuracies both less than and greater than those noted above are also contemplated as the disclosure is not limited to only these accuracy ranges.

In the various embodiments disclosed herein, an average, averaging, or similar term may refer to any appropriate type of average. For example, an average may correspond to taking either a mean, median, and/or mode of a plurality of estimated locations of a landmark and/or other parameters associated with a road surface. In instances where a mean is used, the averaged locations or parameters may simply be summed in the various separate coordinate systems and divided by the total number of estimated locations. In instances where a median and/or any mode are used for averaging the locations or parameters may be subjected to any appropriate type of grouping of the data to facilitate determining the median and/or mode (e.g., binning the estimated locations into different segments of the road surface). Each averaging method may also include appropriate weighting factors for each individual estimate, as elaborated on further below. Accordingly, it should be understood that the various embodiments disclosed herein are not limited to any specific type of average or method of averaging.

Depending on the application, the number of estimated locations and/or other parameters used to establish the location of a landmark and/or to provide a desired measured parameter or other characteristic may correspond to any appropriate number of estimates. For example, in some embodiments, the number of estimates (i.e., measurements) used to determine an absolute location of a landmark or value of a parameter may be greater than or equal to 5, 10, 100, 1000, 10,000, 100,000, 1 million, and/or any other appropriate number. Correspondingly, the number of estimated locations or parameters that may be averaged together may be less than or equal to 10 million, 1 million, 100,000, 10,000, 1000, 100, and/or any other appropriate number. Combinations of the foregoing are contemplated including, for example, a number of estimates that are averaged together that is between or equal to 5 and 10 million though other numbers of estimated locations may also be used. Additionally, depending on the embodiment, the average location of a landmark and/or value of a measured parameter may be a running average where a fixed number of estimates are used to determine the desired location and/or parameter. In such an embodiment, newly measured location estimates and/or sensed parameters may replace older measured location estimates and/or sensed parameters in the dataset as elaborated on further below.

It should be understood that as used herein, a landmark may correspond to any appropriate road surface feature, road side feature, subsurface feature, and/or other feature that may be sensed and identified by a vehicle during operation. For example, as elaborated on below, this may include both intentionally installed or artificial features on a road surface, at a road side position, or below the surface, as well as naturally occurring features associated with a road segment. Additionally, for purposes of this application, the phrases feature, road surface feature, road surface irregularity, or anomaly, and other similar terms may be used interchangeably with the term landmark, though a landmark may also include features that are not located directly on a road surface in some embodiments. For instance in some embodiments, a landmark may include, but is not limited to: features that are located adjacent to a road surface that may be indirectly sensed by a vehicle such as a building, bridge, road sign, tower, a rock, articles of road furniture, a tree, and/or any other appropriate road side feature; subterranean irregularities, or subsurface features, that may be sensed by a vehicle such as a pipe, cavity, a rock, or other buried item; road surface features a vehicle may directly interact with such as a pothole, a manhole cover, a bump, a surface crack, an expansion joint, a frost heave, a rough patch, a rumble strip, a storm grate, and/or other road content; a series or pattern of such anomalies extending over at least a portion of the road surface); a property of the surface, of the road or road segment, such as roughness, friction coefficient, or material (e.g., asphalt, concrete, gravel, etc.); and/or any other appropriate landmark associated with a road segment that may be sensed and identified by a vehicle as the vehicle traverses the road segment.

Sensors that may be used to measure, detect, or otherwise characterized a feature may include, without limitation, accelerometers (e.g., wheel and/or vehicle body accelerometers), LiDAR, inertial measurement units (IMUs), displacement sensors, ranging sensors, cameras, radar, ground penetrating radar, magnetometer, and/or any other appropriate type of sensor capable of sensing one or more types of desired landmark.

As used herein, the term “absolute location” refers to a location specified relative to the earth's surface or relative to a known fixed location relative to the earth's surface. An absolute location may be specified, for example, by providing absolute geographical coordinates of a location, e.g., longitude, latitude, and altitude or any other appropriate location characterization.

The methods and systems disclosed herein may offer numerous benefits. For example, in some embodiments, the improved accuracy and/or up-to-date information related to a landmark and/or a feature associated with the road segment may permit one or more systems of a vehicle to be more appropriately controlled using a priori information related to upcoming portions of the road segment located along a path of travel of the vehicle. The improved location accuracies may also permit this information to be used on a length scale that is relevant to a length scale of the road surface features a vehicle might encounter. For instance, the length scales associated with road surface features a vehicle may encounter may correspond to the length scales of the accuracies noted above where features such as a pothole, a bump, a surface crack, an expansion joint, a frost heave, a rough patch, a rumble strip, a storm grate, and/or other road surface features may have length scales that are between or equal to about 0.005 m and 4.0 m, though other length scales are also possible. Accordingly, the systems and methods disclosed herein may provide a desired level of accuracy and/or up-to-date information relative to a road surface to facilitate the operation of automatic and/or semi-automatic systems of a vehicle using this smaller length scale information which may correspond to lane specific information, tire specific information related to a location of a tire within a lane (e.g. which tire will encounter a road surface feature), the optimal timing to initiate operations relative to an upcoming road surface feature, and/or any other number of operations that may be facilitated by the methods and systems disclosed herein.

Appropriate types of automatic and/or semi-automatic systems of a vehicle that may be operated based at least in part using the road surface information and improved location estimates disclosed herein may include, but are not limited to: suspension systems such as semi-active or fully active suspension systems; propulsion systems of a vehicle (e.g. an internal combustion engine or one or more drive motor(s) of a vehicle); a steering system of a vehicle (e.g. autonomous and/or semi-autonomous vehicle steering and navigation systems); adaptive driver assistance systems (ADAS); electric power steering systems (EPS); antilock braking systems (ABS); lane keeping assistance (LKA); cruise control and/or any other appropriate autonomous and/or semi-autonomous system of a vehicle that may be operated based at least in part on information regarding an upcoming portion of a road segment.

In the various embodiments described herein, information related to a road segment located ahead of the path of travel of a vehicle, including information related to landmarks and/or other road surface characteristics of the road segment, may be provided in any appropriate manner. For example, information about the road ahead of a vehicle, including lane-to-lane differences, may be received from various databases, such as for example, from onboard digital map(s), from other vehicles using vehicle-to-vehicle communication, from cloud-based databases, and/or other appropriate types of databases accessible to the vehicle. In one specific example, a vehicle may include a buffered digital map of a road surface related to the area surrounding the vehicle. The buffered digital map may be downloaded from a remotely located database such as a cloud-based database, another vehicle, and/or a remotely located server. Accordingly, it should be understood that the various embodiments disclosed herein are not limited to any particular type of database that the information related to an upcoming portion of a road surface, including information related to landmarks or features associated with a road segment, is obtained from.

Various embodiments described herein refer to the transmission of signals and/or information between vehicles, databases, satellites, servers, and/or any number of other systems. Accordingly, it should be understood, that in instances where wireless communication or transmission of the signals and/or information are described any appropriate wireless communication method may be used. This may include, for example, radiofrequency transmission protocols, cellular network transmission protocols, wireless network communication protocols (e.g., Bluetooth, Wi-Fi, ZigBee, etc.), and/or any other appropriate type of wireless transmission protocol as the disclosure is not limited in this manner.

As elaborated on further below, in some embodiments, an estimated GNSS location may not be available at the same time and/or location that a landmark is identified and/or a measurement is made by a vehicle. This may occur in instances both where it is desirable to determine a location of a landmark and/or measurement as well as a GNSS localization error of the vehicle. Without wishing to be bound by theory, this may either be due to a GNSS signal not being available at a particular location associated with the landmark (e.g. within a tunnel or other location without GNSS signals) and/or it may be due to a refresh rate of the GNSS location not being synced up in time with the identification of the landmark. For example, in some instances, a GNSS location may only be updated at a rate between or equal to about 1 Hz and 10 Hz such that a GNSS location may be measured either prior to and/or after a location of interest.

In view of the above, the Inventors have recognized the benefits associated with the use of dead reckoning to determine a vehicle location during periods before or after a vehicle interacts with a landmark associated with a road segment, e.g., when sufficiently accurate GNSS readings are not available at a landmark. As elaborated on further below relative to the figures, depending on the specific embodiment, dead reckoning may be used to, e.g., determine an absolute location of the vehicle at a time point prior to and/or subsequent to where the location of the vehicle is known more precisely, than is possible with a single GNSS reading, e.g., a location where a vehicle is interacting with a landmark. For example, information about the distance and direction of travel of a vehicle, prior to when a vehicle interacts with a landmark or after a vehicle interacts with a landmark, may be used to determine the coordinates of a location where a GNSS reading was obtained depending on a timing of the GNSS reading and the vehicle interaction with the landmark.

Such past and/or future absolute GNSS coordinate readings may be used in conjunction with coordinates, determined by the dead reckoning based extrapolation described above, to determine the GNSS error. This method may be used, e.g., when GNSS readings are not or cannot be obtained when the vehicle is interacting with a landmark. Alternatively, other embodiments described herein may also use dead reckoning to determine a vehicle's location relative to any known location either prior to or after a desired time point. These known locations may include locations determined using GNSS location estimates, Relative Localization System (RLS) determined locations, and/or any other appropriate type of location determination method. Appropriate inputs or information that may be used during dead reckoning may include, but are not limited to, wheel speed sensor(s), inertial measurement unit(s) (IMU's), accelerometer(s), sensor on steering systems, wheel angle sensors, GNSS based speed measurements, and/or any other appropriate sensors and/or inputs that may be used to determine the relative movement of a vehicle on the road surface either prior to and/or after the vehicle is present at a landmark or other determined location. This general description of dead reckoning may be used with any of the embodiments described herein implementing either forward looking and/or backwards looking dead reckoning to extrapolate a vehicle location information based on a landmark and/or other determined location for use with the methods and/or systems disclosed herein.

Turning to the figures, specific non-limiting embodiments are described in further detail. It should be understood that the various systems, components, aspects, and methods described relative to these embodiments may be used either individually and/or in any desired combination as the disclosure is not limited to only the specific embodiments described herein.

The absolute location of a vehicle may be determined by, for example, absolute localization systems such as satellite-based systems. Such systems may be used to provide, for example, absolute geocoordinates (i.e., geographic coordinates on the surface of the earth such as longitude, latitude, and/or altitude) of a vehicle. Satellite based systems, generally referred to as a Global Navigation Satellite System (GNSS), may include a satellite constellation that provides positioning, navigation, and timing (PNT) services on a global or regional basis. While the US based GPS is the most prevalent GNSS, other nations are fielding, or have fielded, their own systems to provide complementary or independent PNT capability. These include, for example: BeiDou/BDS (China), Galileo (Europe), GLONASS (Russia), IRNSS/NavIC (India) and QZSS (Japan).

GPS currently includes a constellation of approximately 24 satellites orbiting the earth at an altitude of approximately 20,350 km. Each satellite may circle the earth twice a day in one of six orbits to provide continuous coverage of the earth's surface. Each GNSS (e.g., GPS) satellite may broadcast a signal, typically using a distinct radio frequency, that includes information about the location of the transmitting satellite and the precise time T1 the signal is transmitted. The time T1 may be determined by using an atomic clock onboard the satellite. These signals typically travel at the speed of light C (i.e., approximately 299,792 km/second) and may be received by one or more receivers on Earth.

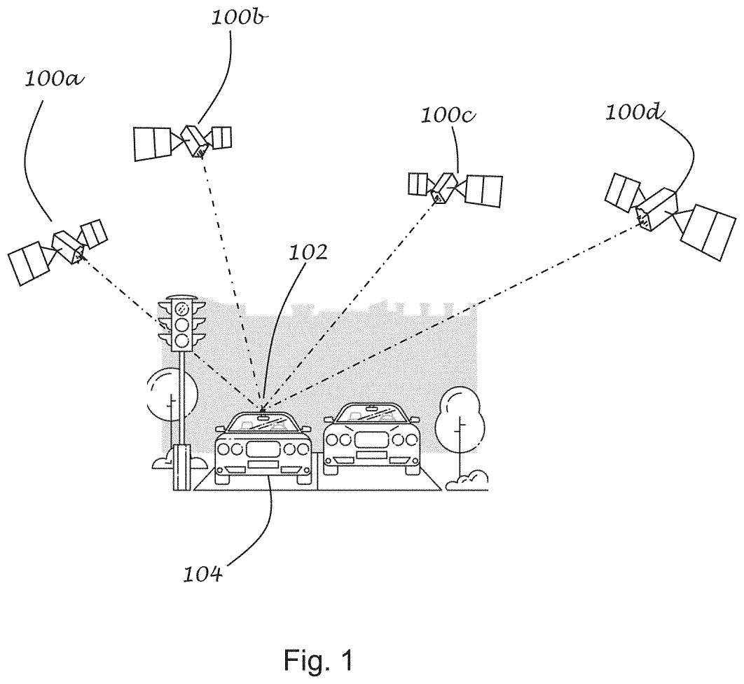

FIG. 1 illustrates four GNSS satellites 100a-100d transmitting signals that are received by a GNSS receiver antenna 102 located in or on a vehicle 104 (e.g., car, van, bus, or truck). Based on the exact time of reception of each signal, T2, (as determined, by using, for example, a clock on board the receiver that receives signals transmitted by the satellites) from each of multiple satellites, the respective times of transmission T1 from each satellite, and the value of C, a microprocessor may be used to compute the distance D between the receiver and each of several satellites that are in view. In some embodiments, when the distance between each of several satellites, from the same or multiple satellites, and the receiver antenna are determined, geometry and information about the location of each of the satellites may be used to determine the location of the receiver on Earth (i.e., absolute location relative to Earth) in three dimensions.

To calculate the distance from a receiver on earth to a satellite, a microprocessor may apply following formula to the signal received from the satellite:

distance=speed of travel×time

where speed of travel used may be C and time may be how long the signal has travelled through space and the Earth's atmosphere to reach the receiver. The signal's travel time may be the difference between the time of broadcast by the satellite T1 and the time, T2, the signal is received at the receiver.

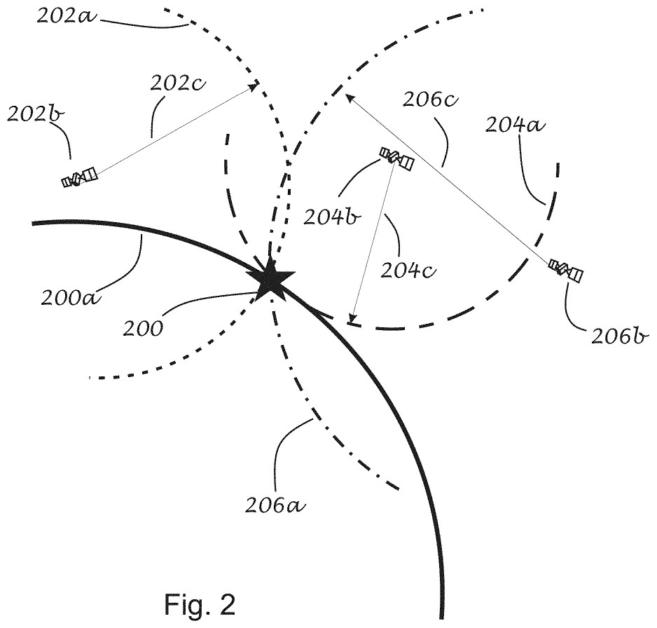

The distance may be used to define a sphere centered on the satellite. When distances to multiple satellites are determined by the receiver, the information may be used to pinpoint the geocoordinates of the receiver. FIG. 2 illustrates the intersection point 200, on the surface of the Earth 200a, determined by the intersection of three spheres 202a, 204a, and 206a, centered on satellites 202b, 204b, and 206b. The radii 202c, 204c, and 206c of the spheres are then computed distances from the receiver to each of satellites 202b, 204b, and 206b, respectively. In FIG. 2, only three GNSS satellites shown for illustration purposes. It is noted that in some embodiments, signals from four or more satellites may be used to determine the geocoordinates of a receiver on earth and the disclosure is not limited to using signals originating from a particular number of GNSS satellites.

The absolute geocoordinates of a GNSS receiver determined, such as by the process discussed above, based on signals received from GNSS satellites may include certain errors or inaccuracies. User accuracy may depend on a combination of factors including, for example: satellite orbit variations, satellite clock drift, local factors, atmospheric conditions, and receiver design features and quality (e.g., precision of the receiver clock). Local factors that may affect GNSS precision include signal blockage and reflection. Signals from satellites may be blocked or reflected by, for example, various structures before reaching a receiver. Such structures may be stationary or moving, naturally occurring or artificial, and may include, for example, buildings, road signs, towers, trees, vehicles (e.g., trucks), and/or ground formations.

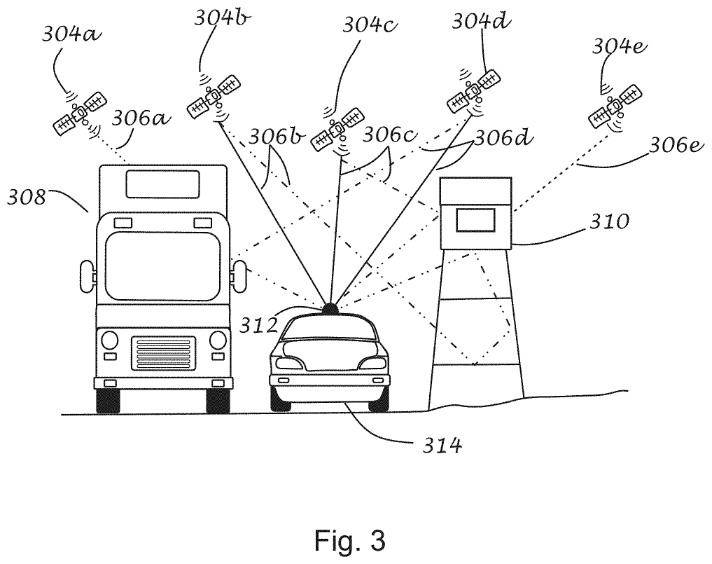

FIG. 3 illustrates examples of local factors such as vehicle 308 and tower 310 that may affect the reception of signals from satellites 304a-304e by GNSS receiver antenna 312 (which may be located in or on a vehicle 314). For example, the signal 306a from satellite 304a and signal 306e from satellite 304e may be completely blocked from reaching receiver 312 by vehicle 308 and tower 310, respectively. On the other hand, the signals 306b-306d from satellites 304b-304d, respectively, may reach the receiver directly, and/or after one or more reflections from various objects. A GNSS receiver may misinterpret a signal that has travelled further, due to for example one or more reflections before reaching the receiver, to be from a satellite that is further away than the source of the signal actually is. Multipath errors may be present in both urban and wooded areas. Some GNSS receivers may be able to minimize interference from signals reflected from below the receiver antenna, but signals reflected from above may be more difficult to eliminate. Additionally, local conditions may change quickly. For example, in the case illustrated in FIG. 3, if vehicle 308 were to move, the signal from satellite 304a may reach the receiver antenna 312 and affect, perhaps substantially, the accuracy with which the absolute location of vehicle 314 may be determined. It is noted, therefore, that the accuracy of GNSS based localization may change rapidly, due to local conditions.

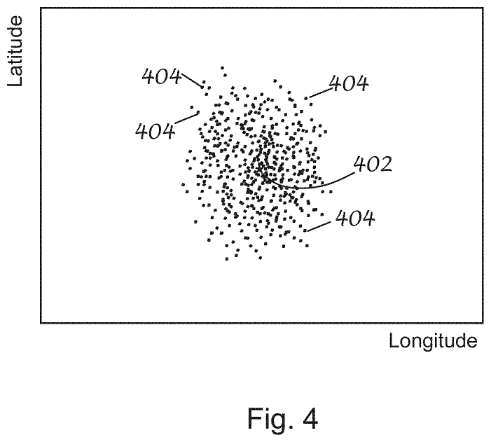

In certain instances, multipath errors caused by reflections may be reduced by, for example, tracking only those satellites that are at least 15 degrees above the horizon, a threshold typically called the “mask angle.” Therefore, the positions of a group of satellites utilized to locate a particular receiver, may affect the accuracy of the measured geocoordinates of the absolute location of a receiver. In some GNSS (including receiver embodiments) the preferred arrangement may be one satellite directly overhead of the receiver and three others equally spaced nearer the horizon (but above the mask angle). This option may not always be available and the geocoordinates, calculated when satellites are, for example, clustered close together in the sky, may suffer from additional imprecision. FIG. 4 illustrates the actual location of a receiver 402, as well as, the variation over time of measurements 404 of longitude and latitude as determined with a single exemplary stationary GNSS receiver. This variation may be due to one or more inherent system inaccuracies such as those discussed above.

In some applications, GNSS augmentation techniques may be used to improve absolute localization accuracy by correcting for certain errors that may cause the distribution of GNSS readings similar to the exemplary distribution illustrated in FIG. 4. For example, a Real Time Kinematics (RTK) system may be used to determine and compensate for certain, though not necessarily all, inherent GNSS based localization errors. RTK relies on a fixed base station receiver, i.e., a non-moving receiver, to estimate GNSS errors.

In some embodiments, the geocoordinates of a single fixed “base station” may be determined to a higher degree of precision by averaging readings obtained by that single receiver over a sufficiently long period of time. Once the geocoordinates of the base station are determined in this manner, that information may be used to estimate GNSS errors of future readings at the location of the receiver. This error estimate may then be broadcast to “rover” receivers (e.g., located in vehicles), to enable the rovers in the vicinity of the base station to correct their GNSS location measurements. It is assumed that the errors at the base station and the rovers are effectively equivalent at any given time.

However, the Inventors have recognized that a single RTK base station has limited range, adds additional cost and complexity, and only corrects for certain errors. For example, a single RTK base station cannot effectively correct for errors in its own clock circuitry. It is noted that an RTK system may also not be able to correct for errors such as those caused by, for example, signal reflection at another location.

Other augmentation techniques may include, for example, Differential Global Navigation Satellite System (DGNSS), Satellite-Based Augmentation System (SBAS), and Precision Point Positioning (PPP). Augmentation systems may be used to reduce but not eliminate GNSS errors. Such augmentation systems also generally add significant additional cost and complexity.

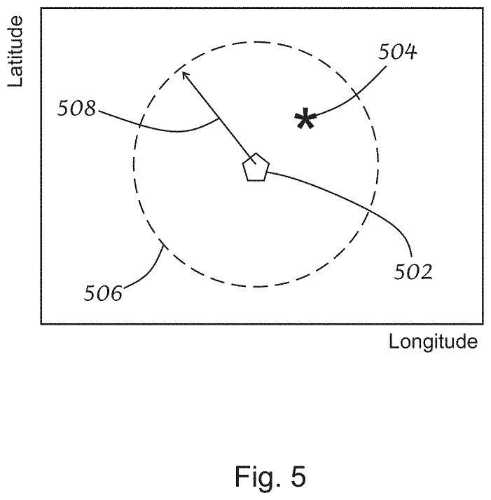

Because of one or more GNSS errors, such as those discussed above, the geocoordinates of the actual absolute location of a vehicle may be at some distance from the geocoordinates measured by a GNSS receiver on board a vehicle. FIG. 5 illustrates the measured location 502 (e.g., longitude and latitude) of a vehicle, as determined by a GNSS receiver on board the vehicle, as well as the actual location 504 (e.g., longitude and latitude) of the vehicle. The region of uncertainty 506, centered around a measured location 502, represents a region where the vehicle may by located with a probability of, for example, 95 percent. In some embodiments, the region 506 may be a circle with a center that coincides with measured location 502. It is noted that other probabilities, such as for example 90 percent, 99 percent, or any other appropriate probability may be used to determine region 506, as the disclosure is not so limited.

The extent or size of the region of uncertainty may be determined by the accuracy of the entire GNSS system (including the receiver on board the vehicle) which may vary from time to time. When the region 506 is circular, the length of the radius 508 may be determined by the accuracy of the GNSS system as a whole. In some embodiments and/or operating conditions, radius 508 may be seven meters long. In some embodiments and/or operating conditions, the radius 508 may be 12 meters long, between 7 and 12 meters long, greater than 12 meters long but less than 30 meters, or less than 7 meters long, as the disclosure is not so limited. The extent of the region of uncertainty, or the length of the radius 508 of the circle of uncertainty, may also vary, for example, as a function of time, as a result of variation in certain parameters of the GNSS, atmospheric conditions, and/or local conditions (e.g., due changes in local conditions as discussed in connection with FIG. 3).

In view of the above, a GNSS may determine and provide an estimate of the location of a vehicle with a receiver. However, a GNSS operating independently is typically incapable of determining the location of a road surface feature and/or a vehicle on a given road segment. Therefore, typically, a vehicle controller may not be capable of determining the distance to an upcoming road surface feature, based purely on data received by a GNSS receiver-regardless of how accurate the GNSS may be. However, without knowing the location of a road surface feature relative to the vehicle with sufficient precision, one or more automatic or semi-automatic vehicle systems (e.g., suspension systems (semi- or fully-active), propulsion systems, ADAS, EPS, and/or ABS, etc.) may not be able to respond appropriately during an interaction with that feature. For example, if the distance between, for example, the front left wheel and a road surface feature, such as a bump, is not known accurately enough (e.g., with an accuracy that is less than or equal to 2 m, 1 m, 0.5 m, 01 m, or 0.01 m) an active or semi-active suspension system, and/or ADAS system may not be able to react effectively and/or in a timely manner to the interaction between the front left wheel and the bump.

Other localization systems, such as a Relative Localization System (RLS), (e.g. a terrain-based localization system or an optical road preview system), may operate differently from absolute localization systems, such as a GNSS. In some embodiments, an RLS may be used to determine the location of a vehicle, or a portion of a vehicle, relative to one or more landmarks associated with a road without precise information about the absolute location of the vehicle. In some embodiments, a GNSS may be used to identify a region of uncertainty where a vehicle may be located. The RLS may then be used to the determine the location of the vehicle relative to one or more landmarks previously determined to be within that region of uncertainty.

A landmark that may be used by an RLS may be a distinctive identifiable road surface feature or other non-road surface feature that may be associated with a road segment or its surroundings. An RLS landmark may be, for example, a road surface feature that produces a distinctive output from one or more sensors on board a vehicle (e.g., a distinctive profile or characteristics of one or more sensed parameters) during an interaction with the landmark.

A landmark interaction may be a contact or a non-contact interaction. An RLS may determine the location of a vehicle relative to a landmark by using pattern matching between current sensor data collected during a current landmark interaction and data previously collected during one or more landmark interactions. If it is determined that there is a sufficient match with data collected at a particular landmark, the RLS may determine that the vehicle is located at that particular landmark.

In some RLS embodiments, during a contact interaction with a road surface feature, one or more sensors (such as for example: accelerometers attached to the sprung mass of a vehicle, accelerometers attached to an unsprung mass of a vehicle, an IMU attached to the sprung mass of a vehicle) may be used to measure an effect on at least a portion of a vehicle. If the data collected during an interaction with such a road surface feature is sufficiently distinctive, at least within the region of uncertainty associated with a GNSS reading, the road surface feature may be considered a landmark and the data collected during an interaction with the road surface feature may be used to determine that the vehicle is located at the landmark.

In some embodiments, an RLS may rely on landmarks that a vehicle does not interact with physically, i.e., the landmark is a non-contact landmark. Such landmarks may include, roadside features or subsurface features that may be detected by, for example, utilizing a camera, LiDAR, ground penetrating radar, or other non-contact sensors as detailed previously above.

As used herein, the term “landmark interaction” refers to a condition where a vehicle is traveling along a road and where one or more sensors on board a vehicle may detect the presence of and/or characterize the landmark. Based on the data collected by the one or more sensors, during a landmark interaction, onboard and/or remote (e.g., cloud based) system(s) may be used to determine the location of the vehicle relative to the landmark. A contact landmark interaction may involve physical contact between a portion of a vehicle, e.g., a wheel or tire, and the landmark, e.g., a road surface feature. Additionally or alternatively, data from a non-contact landmark interaction may involve remote sensing of a landmark where there is little or no contact between the vehicle and the landmark, such as for example, when a camera is used to capture an image of the landmark.

U.S. Pat. No. 9,417,075, filed Nov. 17, 2014, titled “Surface Vehicle Vertical Trajectory Planning;” U.S. patent application Ser. No. 16/130,311, filed Sep. 13, 2018, titled “Road surface-based Vehicle Control;” U.S. patent application Ser. No. 16/672,004, filed Nov. 1, 2019, titled “Vehicle Control Based on Localization and Road Data;” and International Application PCT/US2020/023610, filed Mar. 3, 2020, titled “Vehicular Localization Systems, Methods, and Controls” which are hereby incorporated by reference in their entirety, disclose methods and systems for determining the location of a vehicle relative to one or more landmarks that may include road surface features.

An RLS may be used to refine the location of a vehicle based on a contact landmark interaction after an approximate location of the vehicle has been established by GNSS to be within a region of uncertainty. An RLS may compare data, collected during a current drive, with data collected during previous interactions with one or more landmarks associated with a region or zone of uncertainty identified by a GNSS as the approximate location of a vehicle.

In some RLS embodiments, the current location of a vehicle relative to one or more landmarks may be determined based on the degree of correlation between vertical motion data collected by a sensor, such as vertical motion measured (e.g., with an accelerometer located on an unsprung mass of a vehicle and/or the sprung mass of the vehicle) during a current drive with vertical motion data previously collected during interactions with the one or more landmarks.

Alternatively or additionally, during a non-contact landmark interaction, the relative location of a vehicle may be determined based on the degree of similarity between, for example, an image of a landmark (e.g. a bridge, underground structure, etc.) captured by a camera or other appropriate sensor located onboard a vehicle with images of the same landmark previously captured by cameras on the same or other vehicles. An RLS may also use information collected by any other appropriate type of sensor instead of, or in addition to, accelerometers and/or cameras, as the present disclosure is not limited in this respect.

The number of comparisons relied upon to find a match between current data with previously collected data in a database may be reduced by using a GNSS, for example GPS, to first narrow down the location of the vehicle, e.g., to be within the region of uncertainty of GNSS geocoordinate measurements. Accordingly, only a subset of data characterizing past landmark interactions available in a database may be compared with currently obtained measurements to identify a landmark, and thus, locate the vehicle.

Accordingly, by using a GNSS, one or more absolute location coordinates of a vehicle may be determined to a first level of accuracy, i.e. the level of accuracy of the GNSS. By additionally using an RLS, the one or more location (i.e. relative) coordinates of a vehicle may be determined relative to a landmark to a second level of accuracy, where the second level of accuracy is greater than the first level of accuracy. In some embodiments, the second level of accuracy may be 0.005-1 meters, or other level of accuracy as described herein. Once the relative location of a vehicle with respect to a landmark is determined using RLS, the location of the vehicle as it travels away from the landmark may be determined, in one or more dimensions, for example, by dead reckoning.

The Inventors have recognized that an RLS landmark identification and GNSS location measurements may be used in combination to determine the absolute geocoordinates of landmarks associated with a road or road segment, including, for example, the absolute geocoordinates of various road surface features, roadside features, subsurface features, and/or other appropriate landmarks. In some embodiments, an RLS may be used to determine that a vehicle, with a GNSS receiver, is located at a particular landmark or at a known or measurable distance from the landmark. Contemporaneously with that determination, the absolute geocoordinates of the vehicle may be determined by using the GNSS receiver in the vehicle. The Inventors have further recognized the geocoordinates of the landmark may then be determined based on the geocoordinates of the vehicle located at the landmark.

In some embodiments, one or more geocoordinates of the landmark, also referred to herein as a location, may be assumed to be equal to one or more geocoordinates of the vehicle that is determined to be located at the landmark. Located at a landmark may mean that the vehicle is interacting with the landmark or where the antenna of the GNSS receiver in the vehicle is at a known or measurable distance from the landmark. For example, in some embodiments where the left front wheel of a vehicle interacts with a road surface feature, such as a pothole, the geocoordinates of the pothole may be assumed to be equal to the geocoordinates of the vehicle. Alternatively, the geocoordinates of the pothole may be determined as a function of the geocoordinates of the vehicle after accounting for the offset between the GNSS antenna and the point on the wheel that interacts with the pothole, e.g., a contact patch of a tire of the vehicle.

The Inventors have further recognized that the accuracy of the geocoordinates of a landmark, such as for example, a road surface feature, may be improved by repeating the process described above for multiple vehicle and road surface feature interactions. In some embodiments, the geocoordinates of a given landmark may be determined repeatedly as a plurality of vehicles interact with the same landmark over a period of time. The resulting geocoordinates of the same landmark determined with multiple vehicles may be averaged to determine the geocoordinates of the landmark to a higher degree of accuracy or level of confidence compared to geocoordinates that may be determined by a single GNSS measurement.

When the accuracy of the geocoordinates of a landmark or associated with a landmark are improved to a desired level by the averaging process described above, the landmark may be considered to be a high-accuracy absolute landmark (HAAL). As used herein, the term “high-accuracy absolute landmark (HAAL)” refers to a landmark, associated with a road segment where the geocoordinates are determined by averaging geocoordinates of the landmark as determined during multiple individual vehicle interactions with the landmark. The averaging process may be extended to include data from a sufficient number of interactions to achieve an accuracy level that is above a predetermined threshold value. It should be noted that the absolute location of a HAAL may also be determined using high accuracy sensors mounted on a reference vehicle, as the output of a surveying operation, using satellite imagery, and/or any other appropriate method for determining the location of the landmark with sufficient accuracy and precision.

The Inventors have recognized that once a HAAL is established, i.e., it's absolute location is determined, then the geocoordinates of the HAAL may be used to determine the absolute location of a vehicle that interacts with the HAAL to a higher degree of accuracy than may reliably be determined by using a GNSS alone. As discussed above, RLS may be used to determine that the vehicle is located at the HAAL.

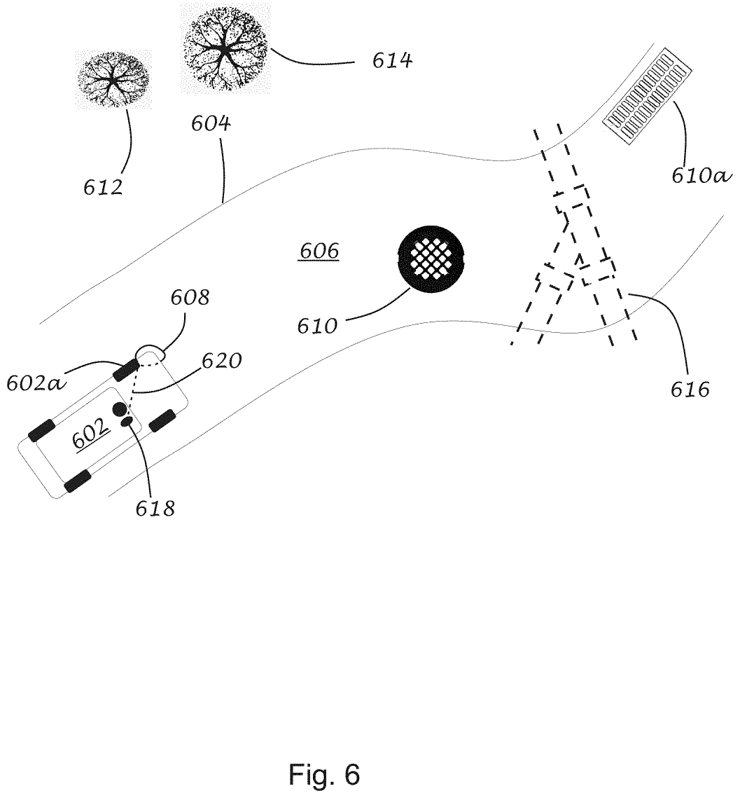

FIG. 6 illustrates a top view of vehicle 602 traveling along road segment 604. Road surface 606 in FIG. 6 includes three examples of road surface features: a pothole 608, a manhole cover 610, and a storm drain cover 610a. Road segment 604 may also include roadside features, such as for example, trees 612 and 614 and/or subsurface features, such as for example, pipe 616. One or more of these features may have been characterized previously and their characteristics stored locally, e.g., onboard the vehicle 602, or remotely, e.g., in a cloud-based database.

In the exemplary illustration of FIG. 6, the left front tire 602a of vehicle 602 has begun to interact with pothole 608. During at least a portion of the interaction between vehicle 602 and pothole 608, one or more sensors on-board the vehicle 602 may be used to collect road-feature information related to the pothole 608. At a point in time after the start of the interaction, an RLS may be used to identify the particular feature based on the road-feature information. Alternatively, the RLS may use information collected during the interaction to establish a landmark if appropriate identifying information about the particular feature is not available in an accessible data base. In the exemplary system illustrated in FIG. 6, simultaneously or effectively simultaneously with the contact interaction between vehicle 602 and pothole 608, the absolute location of vehicle 602 may be determined, for example, by using a GNSS. When the vehicle is in the location shown in FIG. 6, the absolute location of the vehicle as determined by GNSS may be associated with the road surface feature (i.e., pothole 608) and the information may be stored, for example, in a cloud-based data storage. Alternatively or additionally, the geocoordinates of the road surface feature (i.e., pothole 608) may be determined as a function of, e.g., equated to, the absolute geocoordinates of the vehicle at the time of the interaction with the road surface feature. For example, the absolute location of the road surface feature and identifying information about the road feature, or one or more road-surface characteristics, may be associated with each other locally, e.g., in the vehicle, or remotely, for example, in a cloud-based data storage. As shown in FIG. 6, the GNSS antenna 618 of vehicle 602 may be located at a distance 620 from tire 602a. In some embodiments, in determining the absolute location of the pothole 608 or other road surface feature, the measured absolute geocoordinates of vehicle 602 may be adjusted to appropriately account for the offset distance 620.

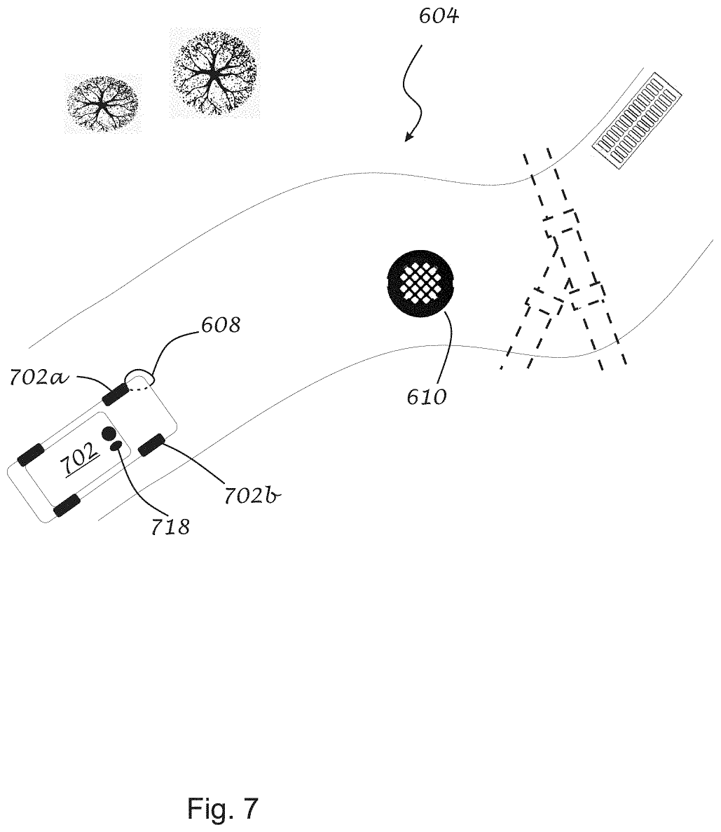

As discussed above, the process described in connection with the interaction between vehicle 602, shown in FIG. 6, with pothole 608, may be repeated over time for the same or one or more other vehicles. For example, FIG. 7 illustrates a vehicle 702 interacting with the pothole 608 of the road segment 604 shown in FIG. 6. Again, as with vehicle 602, simultaneously or effectively simultaneously with the contact interaction of vehicle 702 with pothole 608, the absolute geocoordinates of vehicle 702 at the time of, or effectively at the time of, the contact interaction may be determined. The absolute location of the vehicle as determined by GNSS may again be associated with pothole 608 and stored, locally, in the vehicle or remotely, for example, in a cloud-based data storage. Alternatively or additionally, as described above in connection with FIG. 6, the absolute location of the vehicle, as determined by a GNSS, at the time of the interaction with a road feature may be used to again tag the road feature, such as pothole 608.

In some embodiments, information received from multiple vehicles may include information about the absolute coordinates of each vehicle during a contact or non-contact interaction with a given feature, the absolute location of the contact or non-contact feature, as determined during a vehicle/feature interaction, and/or identifying information about the given feature. The Inventors have recognized that the accuracy of the location of the particular feature may be improved by averaging the geocoordinates of a landmark measured by using GNSS receivers in multiple vehicles. In some embodiments, individual road features may be tagged or associated with the averaged location data (e.g., geocoordinates) obtained from multiple vehicles. In some embodiments averaging of multiple sets of geocoordinates of a given landmark may include the averaging of the latitudes, averaging of the longitudes, and/or averaging of the altitudes from sets of measured geocoordinates. In some embodiments, the averaging of multiple sets of geocoordinates may include the averaging of projections onto a flat surface, for example using a Mercator projection or other known projection methods and then averaging the resulting x and/or y coordinates. In some embodiments, the averaging of multiple sets of geocoordinates may involve projecting them onto a road segment and then averaging the resulting projections in the longitudinal direction of the road segment and/or normal to the road segment, or a combination thereof.

In some embodiments, the averaging may include a weighting factor for each measurement that may be based on knowledge about the quality of the measurement, for example, by considering the number of satellites that were used and/or their locations during each GNSS measurement, the known or estimated accuracy of the measurement based on the types of satellites, angles of the satellites, quality of the receiver, speed of the vehicle at the time of the measurement, or any other appropriate measurement quality metric. For example, data having a lower quality metric may be given lower weightings in the averaged data.

In some embodiments, the quality of data from various vehicles may be evaluated, e.g., after averaging. Based on the evaluation, data from vehicles that frequently or occasionally provide data that are outside the norm, e.g., a predefined number of standard deviations from the mean may discarded and not included in the averaging processes in the future. Alternatively, data from vehicles that frequently provide poor quality data may be give less weight relative to data from vehicles that consistently provide data that is of an acceptable quality, i.e., within a predetermined error threshold. However, other appropriate averaging methods are contemplated as the disclosure is not so limited.

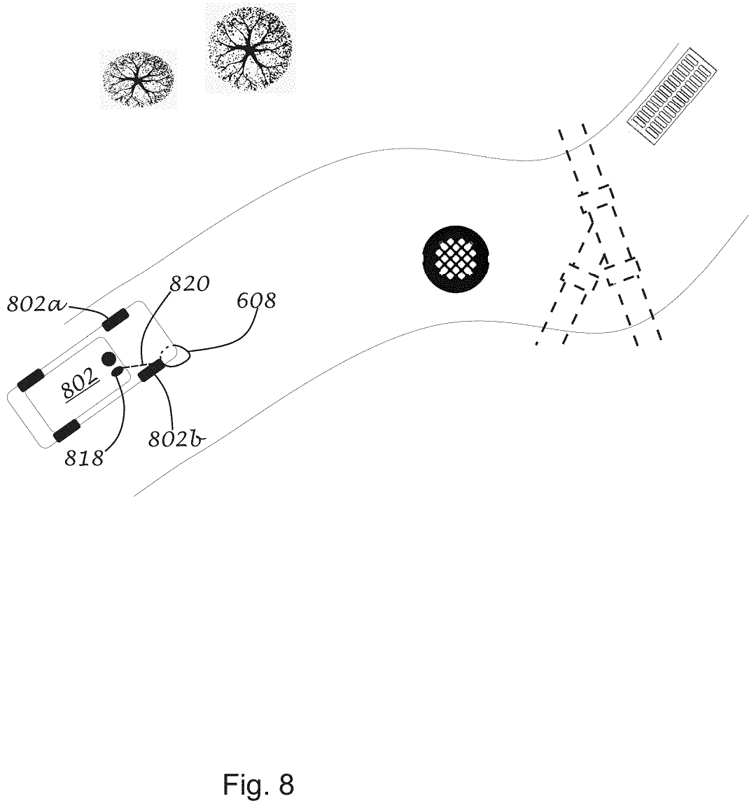

FIG. 8 illustrates the right front tire 802b of vehicle 802 undergoing contact-interaction with pothole 608 that is shown in FIGS. 6 and 7. In this embodiment, the geocoordinates of the landmark may be determined by accounting for offset between the GNSS receiver antenna 818 of the vehicle and the portion of the vehicle that interacts with the landmark, e.g., tire 802b. As shown in FIG. 8, the GNSS antenna 818 of vehicle 802 may be located at a distance 820 from tire 802b. In some embodiments, in determining the absolute location of the pothole 608 or other road surface feature, the measured absolute geocoordinates of vehicle 802 may be adjusted to properly account for the offset distance 820. This adjustment may be different than the adjustment due to distance 620 in FIG. 6.

In FIGS. 6-8, a vehicle is shown to be undergoing a contact-interaction with a pothole 608. It is understood however, that GNSS absolute location data may be associated with any appropriate feature (e.g., road-surface, roadside, or subsurface feature) based on information collected during a contact and/or non-contact interaction, as the disclosure is not limited to a particular type of feature or interaction.

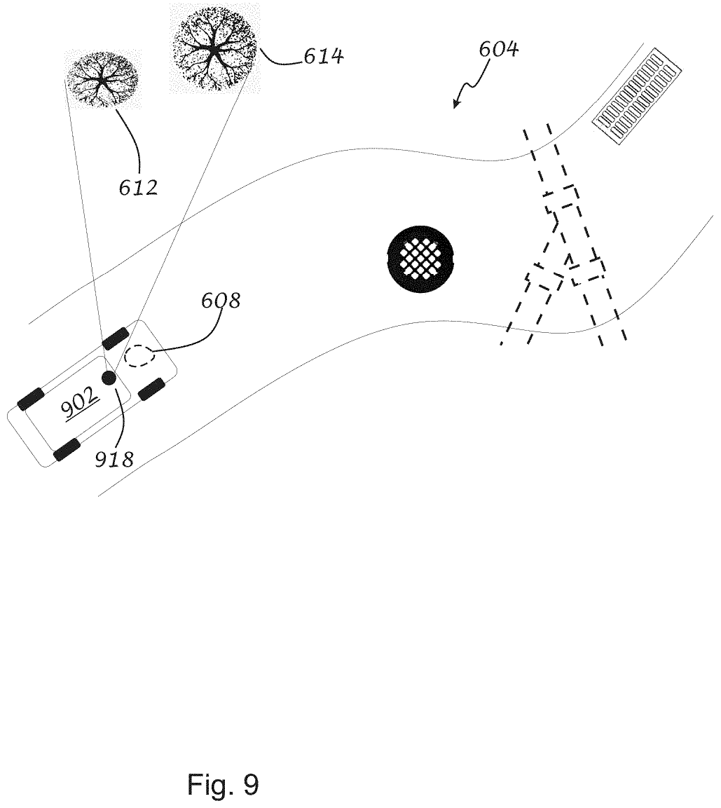

FIG. 9 illustrates vehicle 902 travelling along the road segment 604, shown in FIGS. 6-8. However, in this case the front tires of vehicle 902 straddle pothole 608 and contact interaction with the pothole may not occur. However, as shown in FIG. 9, vehicle 902 may undergo non-contact interaction with roadside features such as trees 612 and 614. Image capture sensor 918, which may be for example a video camera or a LiDAR sensor, may be used by an RLS system to locate the relative location of vehicle 902 relative to one or more road side features, i.e., tree 612 and/or tree 614. As discussed in connection with FIGS. 6-8, after multiple non-contact interactions with trees 612 and/or 614, absolute coordinates may be assigned to, or otherwise associated with, landmarks 612 and/or 614 such that they may be used in combination or individually as HAALs.

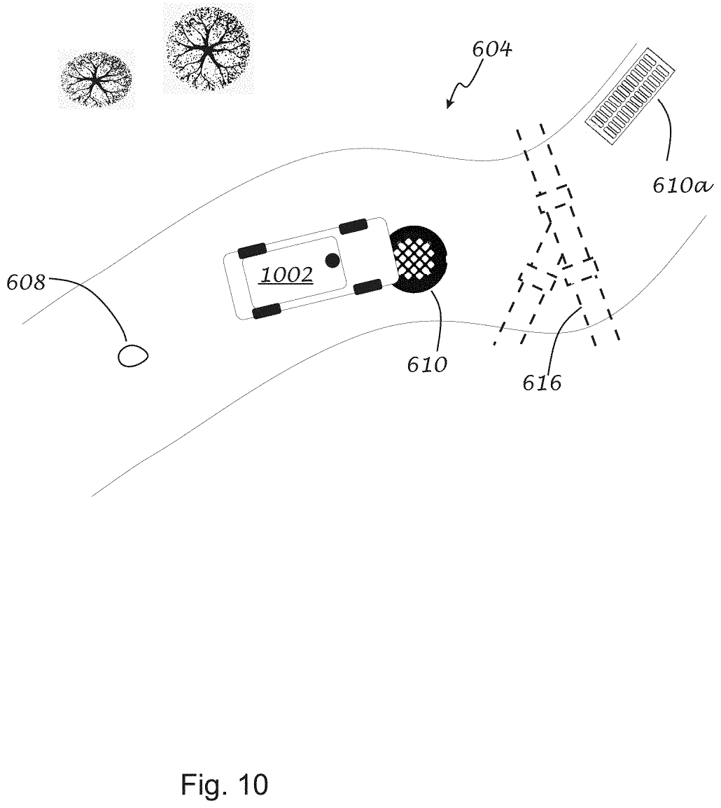

Additionally or alternatively, as illustrated in FIG. 10, vehicle 1002 may undergo contact-interactions with one or more additional features associated with road segment 604, such as for example manhole cover 610 and storm drain cover 610a, and or noncontact interactions with subterranean pipe 616.

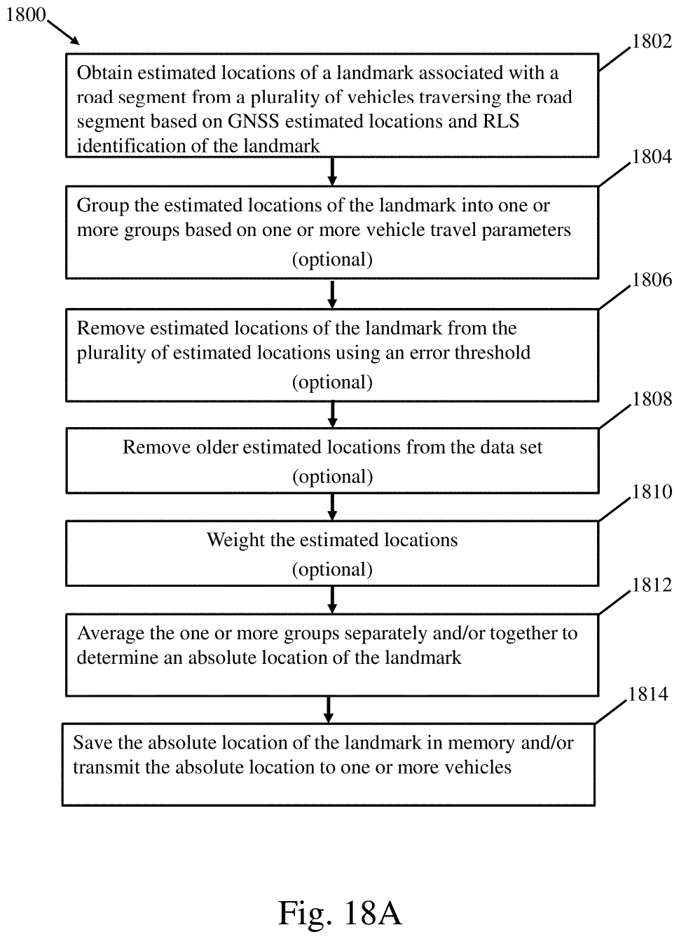

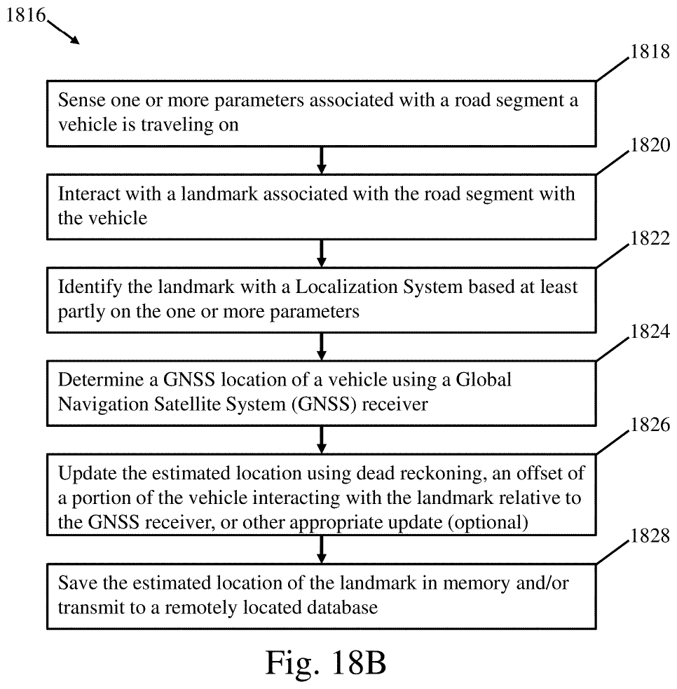

FIG. 18A depicts one embodiment of a method 1800 for determining an absolute location of a landmark associated with a road or road segment. As noted previously, this landmark may either correspond to a road surface feature disposed on the road segment and/or it may include landmarks that are adjacent to and/or disposed beneath a road segment depending on the particular embodiment and types of sensors used to detect the landmark. Additionally, in some embodiments, the depicted method may be implemented using one or more processors associated with a remotely located server, or other database, that is remotely located from the plurality of vehicles interacting with landmark. Correspondingly, the one or more processors may be associated with corresponding non-transitory computer readable memory that includes processor executable instructions that when executed perform the methods described herein.

As noted previously, the characteristics and/or location of a landmark may evolve over time relative to a road segment. Additionally, in some instances, it may be desirable to identify and map the presence of landmarks on a new or unmapped road segment without the expense and delay associated with characterizing the road segment with a dedicated characterization system. Accordingly, it may be desirable to use location information associated with landmarks identified by a plurality of vehicles traversing a road segment to determine the absolute location of a particular landmark. In some embodiments, a plurality of estimated locations of a landmark associated with a particular road segment may be obtained from a plurality of vehicles traversing the road segment at 1802. An appropriate localization system, such as a Relative Localization System (RLS) as described above, may be used to identify one or more landmarks associated with the road segment as each vehicle traverses that portion of the road segment. Each identification of a landmark may be associated with a corresponding estimated location of the landmark. For example, the estimated locations may be based at least in part on a GNSS estimated location of the landmark by each vehicle. Thus, it may be possible to obtain a dataset that may be used to determine the absolute location of one or more landmarks associated with a road segment using data that may be sourced from vehicles traversing the road segment either in the past and/or in real time.

In some embodiments, it may be desirable to group the estimated locations of a landmark into two or more separate groups according to certain characteristics of the interactions between the vehicles measuring a given estimated location of the landmark, see 1804. For example, when averaging the absolute geocoordinates of a landmark, only coordinates measured when the vehicle is traveling in certain directions of travel may be considered. Also, in some embodiments, when averaging geocoordinates of a road feature, data may be grouped depending on, for example, which side of a vehicle, e.g., left, right, front, or rear, is interacting with the feature, prevalent weather conditions, e.g., rain, snow, or ice, or other factors. For instance, a pothole going in one direction may have a different sensed profile, e.g., leading-edge location in a first direction as compared to a second opposing direction. Similarly, a particular road surface feature, such as a pothole, may exhibit different characteristics in different weather conditions such as a dry pothole versus a pothole filled with snow and/or water. Accordingly, it should be understood that the estimated locations of the landmark may be grouped or considered according to any desired parameter associated with a vehicle traversing a road segment and/or environmental conditions associated with the road segment when a particular measurement is made. Depending on the embodiment, the separate groups of estimated landmark locations may either be weighted differently and/or averaged separately for use in different applications (e.g., different directions of travel on the road segment).

In some applications it may be desirable to remove estimated locations from a dataset used to determine an absolute location of the landmark that exhibit an error that is greater than a predetermined error threshold, see 1806. This may help to avoid introducing errors into the determined absolute location of a landmark by using unreliable estimated locations. In some embodiments, a previously determined absolute location of a landmark may be available. In such an instance, the predetermined threshold error may either correspond to a distance threshold such that location estimates greater than the predetermined distance threshold may be excluded from the dataset. Alternatively, location estimates that are distanced from the predetermined absolute location by more than a 1, 2, and/or any other appropriate predetermined number of standard deviations from the predetermined absolute location may be excluded. Instances in which data with errors greater than a predetermined error threshold are removed from a dataset after an initial averaging process are also contemplated. In other embodiments, a vehicle may have already been identified as providing unreliable data, e.g., based on an error threshold associated with one or more other separate landmarks. Accordingly, in some embodiments, location estimates provided by a vehicle that has previously been identified as providing unreliable data may be discounted, or at least given a lower weighting relative to other location estimates in the dataset. Of course, any other appropriate type of method may be used to exclude unreliable location estimates from the dataset used to determine an absolute location of a landmark relative to a road segment.

In some embodiments, it may be desirable for an absolute location and/or other characteristics of a landmark associated with a road segment to be updated over time to ensure that a map or other characterization of the road segment remains current with actual conditions present on the road segment. Accordingly, in some embodiments, older location estimates may be removed from the dataset while newer location estimates are added to the dataset at 1808. For example, location estimates that are older than a predetermined time period may be removed from the dataset. Alternatively, a predetermined number of location estimates may be used such that when a new location estimate is added to the dataset the oldest location estimate may be removed from the dataset to maintain a desired number of location estimates in the dataset. In yet another embodiment, the measured location estimates may be merged with an already determined location of a given landmark using any appropriate merging method including, for example, averaging as discussed herein. After averaging, in some embodiments, the estimated locations may be discarded to conserve storage. Combinations of the foregoing are also contemplated. For example, a portion of the estimated locations may be merged together another portion of the estimated locations may be kept separate as the disclosure is not limited to how the dataset is handled or stored. In either case, the dataset may evolve over time such that it reflects current conditions of the road segment.

In some instances, it may be desirable to weight certain location estimates differently based on various characteristics or information associated with each of the location estimates, see 1810. For example, location estimates may be weighted based on a reliability of the identification and estimated location data. In one such embodiment, a vehicle may have been identified as providing unreliable data in one or more prior instances based on an error threshold, see 1806 above. Correspondingly, another vehicle may have been identified as providing reliable data in one or more prior instances based on the error threshold. Correspondingly, estimated locations provided by vehicles that have previously provided more reliable data may be given a greater weighting during an averaging process as compared to estimated locations provided by vehicles that have previously been determined to provide unreliable data. Such weighting may also be provided on a spectrum. For example, increased frequency of unreliable data being provided by a vehicle, as determined using error thresholds or other appropriate techniques, may result in a reduced weighting being applied to the estimated locations provided by that vehicle. Additionally, in some instances, it may be desirable to provide a weighting of zero, i.e. exclude, estimated locations associated with measurement conditions that might result in invalid measurements. For instance, landmark identifications and corresponding estimated locations associated with laser and/or optical-based sensing systems may be unreliable during fog and/or heavy rain. Accordingly, estimated locations associated with these types of systems and conditions during measurement may be excluded from the datasets and/or provided a lower weighting as compared to other location estimates in the dataset for example when an average is being computed. Based on the foregoing, it should be understood that any appropriate type of weighting metric may be applied to the estimated locations used to determine an absolute location of the landmark as the disclosure is not limited in this fashion.

Depending on the particular application and type of sensing systems used, any of the above treatments of the resulting dataset may be used either individually and/or in combination with one another to provide a dataset for determining the absolute location of the landmark. This dataset may include individual estimates, merged estimates, combinations of the foregoing, and/or any other appropriate type of dataset as the disclosure is not so limited. Regardless of the specific processes applied, once a set of estimated locations of the landmark is obtained, the one or more groups of estimated locations may either be averaged separately and/or together to determine an absolute location of the landmark, see 1812. As noted previously, this average may correspond to a mean, median, and/or mode of the estimated locations of the landmark. The absolute location of the landmark may then be stored in an associated non-transitory computer readable memory and/or it may be transmitted to one or more vehicles for use in a localization, navigation system, or one or more controllers on-board the vehicles at 1814. In some instances, the absolute location of the landmark may be associated with a map of the road segment and/or other appropriate characterization of the road segment.

It should be understood that each of the estimated locations obtained as part of a dataset may be provided in any appropriate manner. One such exemplary embodiment that may be implemented by each of a plurality of vehicles traversing a road segment including a landmark to be located is shown in the method 1816 illustrated in FIG. 18B. As depicted in the figure, a vehicle may sense one or more parameters associated with a road segment the vehicle is traveling on at 1818. For example, an IMU, accelerometer, a laser or optics-based look ahead sensor, x-ray sensor, and/or any other appropriate type of sensor may be used to sense one or more parameters of one or more features associated with the road segment. In one such embodiment, the accelerations of one or more unsprung masses, e.g., a vehicle wheel and/or sprung mass, e.g., body of the vehicle, may be sensed to characterize one or more features associated with a road segment the vehicle is traversing. Regardless of the specific type of sensor, the vehicle may interact with a landmark associated with the road segment via either a contact-based interaction and/or a non-contact interaction as may occur using a non-contact sensor at 1820. Sensor signals from the one or more onboard sensors may be transmitted to one or more corresponding processors that may be used to implement an appropriate localization system, such as a Relative Localization System (RLS), that may be used to identify the landmark at 1822. Specifically, the one or more sensed parameters during the interaction with the landmark may correspond to a particular pattern of the sensed parameters associated with that landmark. The localization system may identify this pattern, and thus, identify the presence of the landmark relative to the vehicle as described in more detail above.

Once a particular landmark has been identified by a local system, e.g., a system on-board a vehicle and/or a remote system, e.g. a system in the cloud, in some embodiments, a Global Navigation Satellite System (GNSS) receiver may be used to determine a GNSS location of the vehicle at 1824. Due to the inherent error in most GNSS locations, and the ability of the errors to be averaged out across a large number of estimated locations, in some embodiments, the GNSS location of the vehicle may be used as the estimated location of the landmark. However, in some embodiments, it may be desirable to update the estimated location of the landmark to account for various offsets in 1826. For example, as described previously, an offset of a portion of the vehicle interacting with the landmark relative to the location of a GNSS sensor (e.g., a GNSS receiver antenna), and/or an offset from a measured location of the landmark relative to the location of a GNSS sensor (e.g., a GNSS receiver antenna) may be determined. This determined offset may then be combined with the measured GNSS location of the vehicle to provide the estimated location of the landmark. For example, in some embodiments, the offset may be applied to the vehicle location to determine the landmark location. Additionally, as also described above, in some instances, a measured GNSS location of a vehicle may not correspond exactly to a location of the vehicle when the landmark was identified due to, for example, the GNSS location updating either prior to and/or after the vehicle interacted with the landmark. In such instances, in some embodiments, either forward looking and/or backwards looking dead reckoning may be applied to a measured GNSS location of the vehicle to provide an updated GNSS location of the vehicle when the landmark was identified. In such an embodiment, the updated GNSS location of the vehicle, with or without an appropriate offset, may be used as the estimated location of the landmark.

After appropriately identifying an interaction of a vehicle with a landmark and determining an estimated location of the landmark, the vehicle may either save the estimated location of an identified landmark in a non-transitory computer readable memory of the vehicle for subsequent download and/or usage or the vehicle may transmit the information to a remotely located database at 1828. In either case, such an identification and associated location measurement method may be implemented by any appropriate number of vehicles such that one or more landmarks associated with a given road segment may be appropriately characterized and located both quickly and in a manner that is flexible enough to enable real-time updates of the characteristics and locations of these landmarks over time.

Using the above embodiments, once the absolute geocoordinates are determined to a sufficiently accurate degree and/or level of confidence and a HAAL is established, the HAAL may be used as a GNSS base station. In some embodiments, “sufficiently accurate degree” may be geocoordinates that are within 0.005-5.0 meters of the actual geocoordinates. Further, absolute geocoordinates may be considered to be sufficiently accurate over this entire range, or one or more sub-ranges as the disclosure is not so limited. For example, absolute geocoordinates may be considered sufficiently accurate in the range 0.01-1.0 meters from the actual geocoordinates, in the range 0.1-2.0 meters from the actual geocoordinates, or in the range 0.01-5.0 meters from the actual geocoordinates. Accuracies above and below the above ranges, or any other appropriate range are contemplated as the disclosure is not so limited.

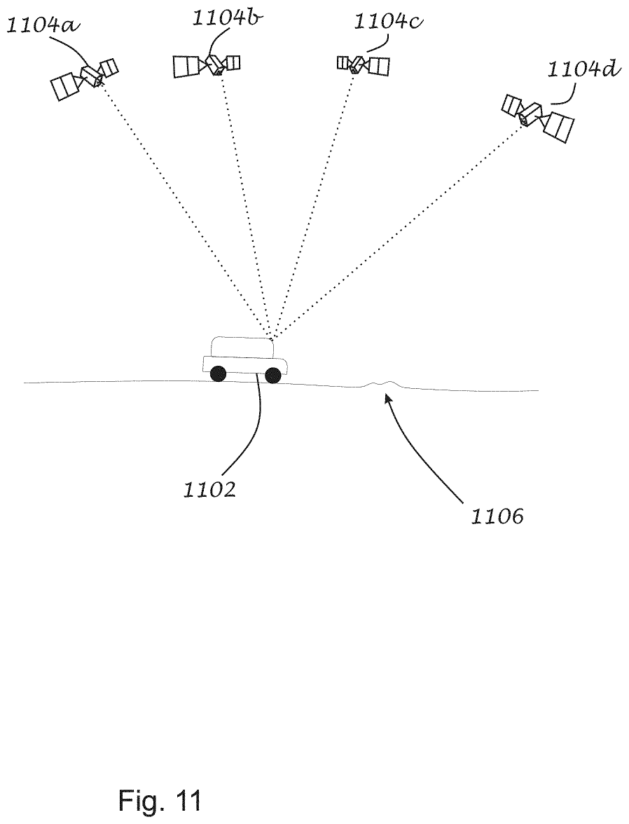

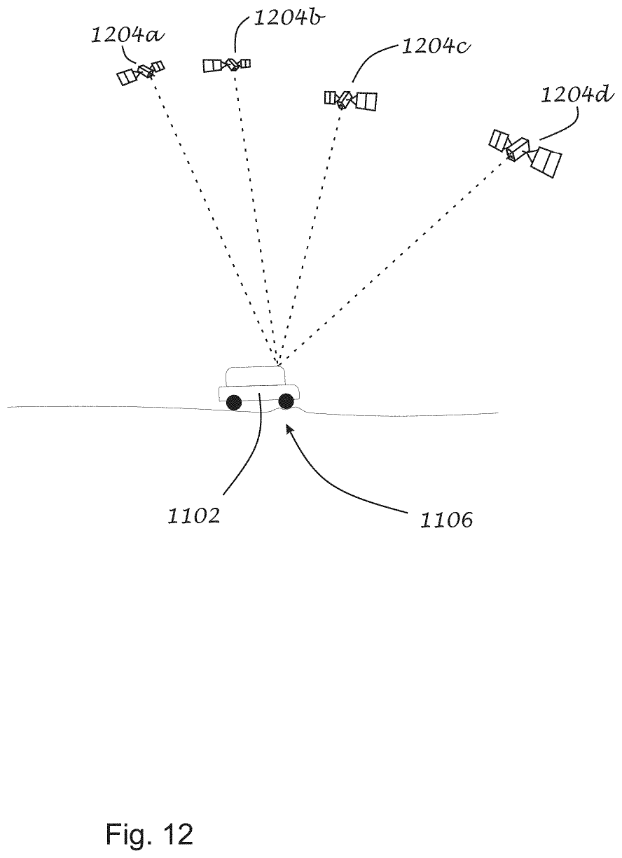

As noted above, it may be desirable to accurately determine the location of a vehicle in order to enable the meaningful use of a prior information related to the path of travel of a vehicle, and it may be desirable to provide improved accuracy in the measured location of a vehicle as compared to typical GNSS based location measurements. Accordingly, the Inventors have recognized the benefits associated with the use of a HAAL as a base station to determine GNSS errors for one or more satellites in one or more constellations and to then provide GNSS corrections to vehicles in a particular region. For example, FIG. 11 illustrates an exemplary vehicle 1102 which may be receiving GNSS signals from satellites 1104a-1104d, all of which may be in, for example, a single constellation. The vehicle may be approaching a previously established HAAL 1106. In FIG. 12, vehicle 1102 is shown to be located at HAAL 1106. One or more microprocessors, located in vehicle 1102 and/or the Cloud may be used to identify the HAAL based on RLS and/or GNSS data. When the HAAL 1106 is identified, its geocoordinates may be accessed, e.g. in a local or remote database, and compared to a current GNSS measurement of the location of the HAAL. Based on this comparison, the current GNSS error at the location of HAAL 1106 may be determined. The error may be determined on a per satellite basis, such as for example, by determining the timing and/or distance error between the receiver in the source vehicle and one or more satellites. Alternatively or additionally, an error may be determined based on the difference between the geocoordinates of the HAAL and the geocoordinates determined by the receiver, in the source vehicle 1102, based on current GNSS measurements.

Once a GNSS error is determined, it may be used locally by the source vehicle 1102 for example for more precise navigation and/or controlling, at least in part, the operation of one or more automatic and/or semi-automatic systems of the vehicle, such as for example, an active or semi-active suspension system, a power steering system, a braking system, an advanced driver-assistance system (ADAS), and/or any other appropriate system. Alternatively or additionally, as discussed above, the error determined during the interaction between a source vehicle 1102 and HAAL 1106 may be conveyed to or shared with other consumer vehicles in the vicinity of the HAAL and/or with a remotely located server, including a Cloud-based server. The error data may then be used by one or more other consumer vehicles (not shown) or in the Cloud to correct the GNSS geocoordinates received by one or more GNSS receivers located in consumer vehicles. The error information may be conveyed to or shared with consumers by broadcasting the information using WiFi, the internet, cell phone communication, or any other appropriate form of communication protocol, as the present disclosure is not limited in this respect. It is noted that consumers are not necessarily vehicles but may be any apparatus that includes a GNSS receiver, such as for example, a cell phone. It is further noted that such error information associated with a group of GNSS satellites or individual GNSS satellites may be collected by multiple source vehicles interacting with multiple HAALs simultaneously or effectively simultaneously. Such information from multiple source vehicles may be shared with one or more central data collection and/or analysis networks, such as cloud-based data collection and/or analysis networks.

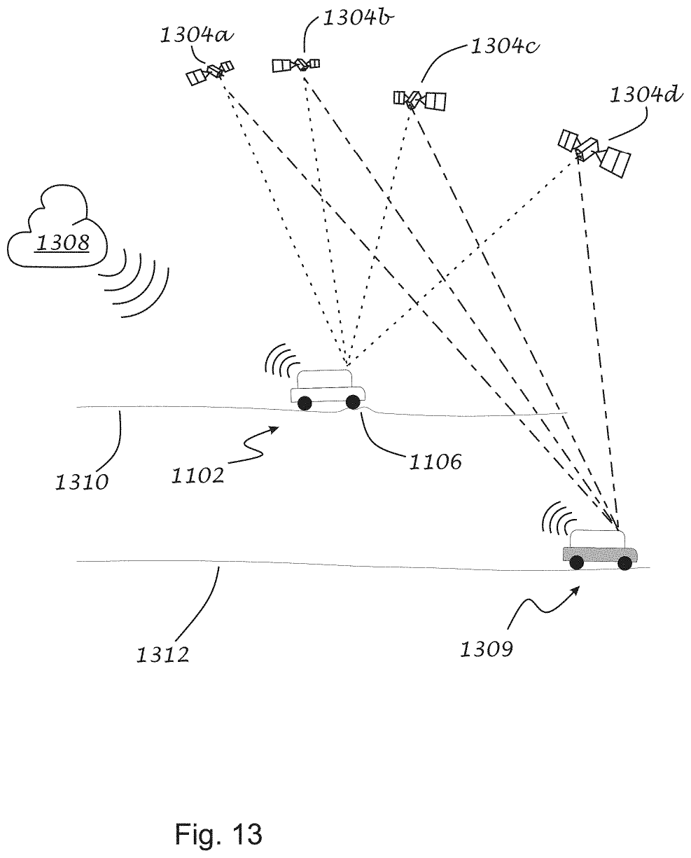

FIG. 13 illustrates source vehicle 1102 receiving GNSS signals from, for example, four satellites 1304a-1304d while interacting with HAAL 1106. In some embodiments a processor in vehicle 1102 may compute the error of geocoordinates determined based on the signals from satellites 1304a-1304d when compared to the previously determined location of HAAL 1106. Alternatively or additionally, a processor in source vehicle 1102 may determine the timing and/or distance error for one or more individual satellites or group of satellites. Source vehicle 1102 may then convey the error information to a cloud-based network 1308. The cloud-based network may in turn convey error information to consumer vehicle 1309 which, in the embodiment of FIG. 13, may also be receiving GNSS signals from satellites 1304a-1304d. Alternatively or additionally, vehicle 1102 may provide information, which may include data about its location at HAAL 1106, and geocoordinate-based data from satellites 1304a-1304d, to cloud-based network 1308. A processor in the network may then be used to compute the errors in GNSS-based location determinations in the region or based on a particular set of satellites.

Once GNSS errors are determined by one or more microprocessors, whether one or more of the microprocessors are located in vehicle 1102 and/or remotely, those errors may be transmitted or otherwise conveyed to a consumer vehicle (not shown) which may be traveling on the same road 1310 as source vehicle 1102. Alternatively, as shown in FIG. 13, vehicle 1309 may be traveling on a different road 1312 that is also in the vicinity of HAAL 1106. GNSS errors at the consumer vehicle 1309 may be the same or effectively the same as the errors at source vehicle 1102, that is obtained at the same time or effectively the same time. It is noted that the same vehicle may, on one occasion, be a source vehicle while on another occasion or at the same time it may be a consumer of GNSS error data.

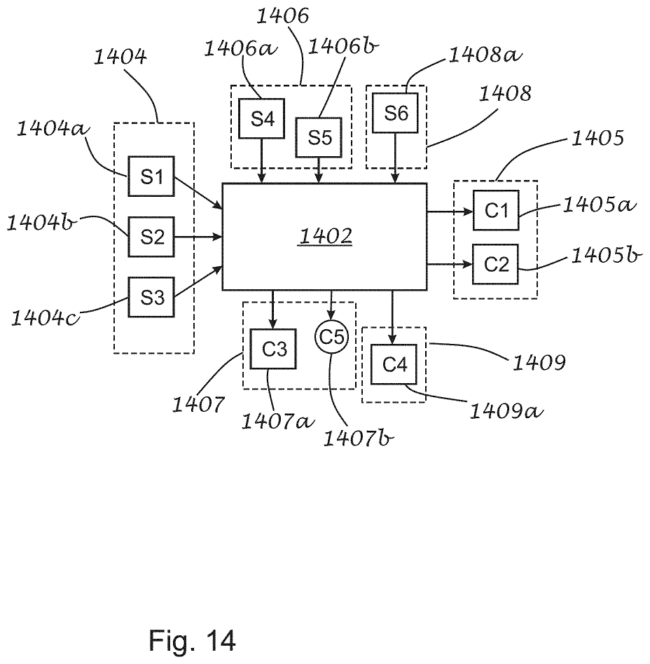

FIG. 14 illustrates an exemplary cloud-based network 1402 that receives GNSS error correction data from source vehicles 1404a, 1404b, and 1404c travelling in region 1404, from source vehicles 1406a, and 1406b travelling in region 1406, and/or from source vehicle 1408a, traveling in region 1408. Such error correction information may include timing and/or distance measurement error(s) associated with one or more individual satellites. Alternatively or additionally, the error correction information may include geocoordinate or other errors associated with one or more groups of satellites. In FIG. 14, the cloud-based network 1402 may also provide error correction information to consumer vehicles 1405a and/or 1405b, which may be travelling in region 1405, vehicle 1407a, which may be travelling in region 1407, and/or vehicle 1409a, which may be traveling in region 1409. Regions 1404, 1406, and 1408 may completely and/or partially coincide with regions 1405, 1407, and 1409, respectively or may be totally different regions. It is noted that network 1402 may also provide error correction information to consumers that are not vehicles such as consumer 1407b, which may be, for example, a cell phone.

The Inventors have also recognized that even when a source vehicle may be located at some distance from a HAAL, its onboard GNSS receiver may be used to receive GNSS signals that may be used by a microprocessor, on board the vehicle or located at a remote location, to determine error(s) in GNSS.

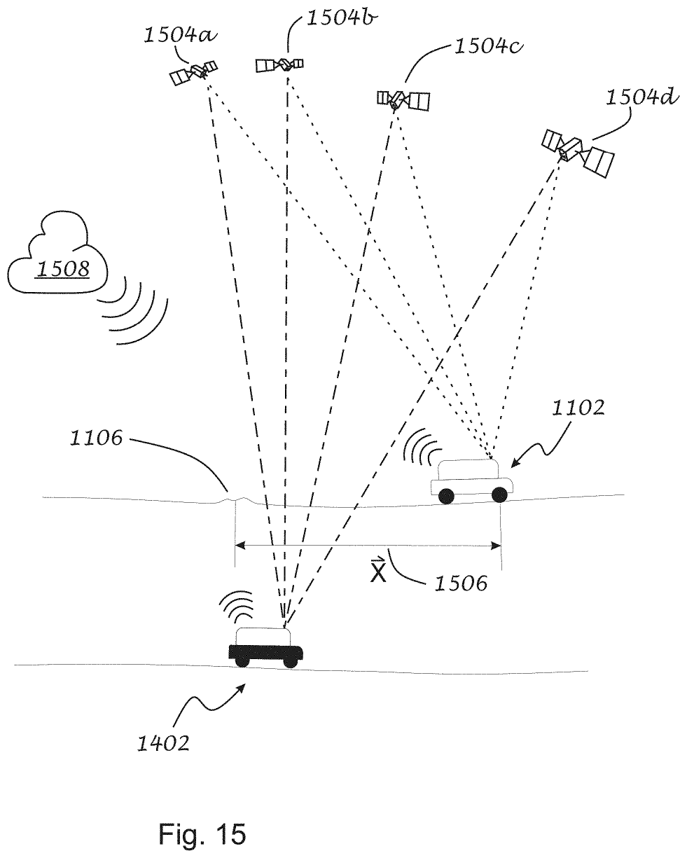

FIG. 15 illustrates vehicle 1102 which is located at some distance from HAAL 1106. The location of the vehicle 1102 relative to the HAAL 1106 may be represented by vector \vec{X} which may be a two- or three-dimensional vector. Given that the absolute location of HAAL 1106 is known, information gathered by a GNSS receiver in vehicle 1102 may still be used to determine GNSS error.

In some embodiments, the magnitude and direction of the vector \vec{X} may be determined by dead reckoning. Accordingly, the absolute location of the vehicle may be determined or computed even when the vehicle is at a distance from the HAAL 1106. GNSS receiver in vehicle 1102 may be used to collect GNSS signals from satellites 1504a-1504d. Relying on such satellite data, information about the location of the HAAL, and the distance travelled from the HAAL (e.g. determined by dead reckoning), GNSS error data may be determined, in a similar fashion to the process described in the discussion about FIG. 13, even when the source vehicle is not located at a HAAL. Similarly, once the GNSS error is determined, that information may be conveyed to other vehicles that rely on one or more of satellites 1504a-1504d to locate their positions. The information may be conveyed by using a cloud-based network 1508, but other appropriate methods of conveying information from source vehicles such as vehicle 1102 to a consumer vehicle 1402 are contemplated as the disclosure is not limited to a specific method to conveying the error data.

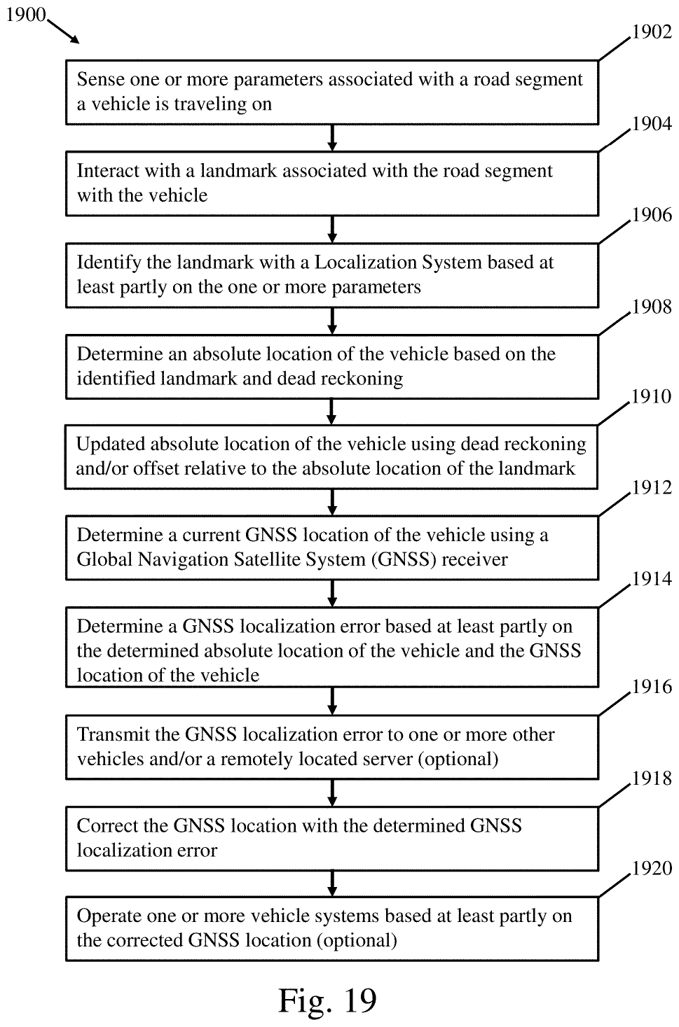

FIG. 19 depicts one embodiment of a method 1900 that may be used to determine a GNSS localization error. In some embodiments, the depicted method may be implemented using one or more processors that are onboard a vehicle or located at one or more remote locations, e.g. in the cloud, that is either used to determine a GNSS localization error and/or that receives and uses the GNSS localization error. Correspondingly, the one or more processors may be associated with corresponding non-transitory computer readable memory that includes processor executable instructions that when executed perform the methods described herein.

At 1902 a vehicle including one or more onboard sensors may be operated to sense one or more parameters associated with one or more features associated with a road segment the vehicle is traveling on. As noted previously, any appropriate type of sensor may be used to sense road surface feature, roadside feature, and/or subsurface feature parameters. As the vehicle continues to traverse the road segment, the vehicle may interact with a landmark associated with the road segment at 1904. As described in further detail above, this may include both contact and non-contact interactions with a landmark. For example, an IMU and/or accelerometer may sense acceleration of a wheel and/or body of a vehicle when height variations in the road surface are encountered by the vehicle due to road surface features being present along a path of travel of the vehicle. Alternatively, non-contact sensing might include the sensing of objects beneath the road surface and/or objects adjacent to the road surface that are not in the direct path of travel of the vehicle. In either case, after detecting the one or more parameters that may be associated with a particular landmark, a localization system, such as a Relative Localization System (RLS), of the vehicle may identify a landmark based on a comparison of the sensed profile of the one or more parameters to a previously identified profile associated with the landmark. This profile of the landmark, as well as corresponding location information, may be obtained from either a database onboard the vehicle and/or a remotely located database. In either case, after the localization system has identified the landmark, the localization system may also determine an absolute location of the vehicle based at least in part on the known location of the identified landmark. For example, the location of the identified landmark may be a high accuracy absolute landmark (HAAL) as described herein.

In some embodiments, the absolute location of a vehicle may be assumed to be the same as the absolute location of the identified landmark at a time point when the vehicle interacts with the landmark. However, as noted above, in some instances it may be desirable to update the absolute location of the vehicle based on one or more consideration shown in 1910. For example, as described above relative to FIGS. 6-10, a portion of a vehicle that interacts with the landmark may be offset from a portion of the vehicle used to a provide a measured location of the vehicle. Alternatively, the landmark may not be in the direct path of travel of the vehicle in some embodiments. Accordingly, in some instances, the absolute location of the vehicle may be updated by applying an offset between the location of the identified landmark and a portion of the vehicle (e.g. a GNSS receiver of the vehicle). Additionally, in instances where it is desirable to determine an absolute location of the vehicle either prior to and/or after identification of landmark, dead reckoning may be used to determine an absolute location of the vehicle relative to the absolute location of the landmark using any appropriate source of direction and distance of travel of the vehicle as previously described.

In addition to determining an absolute location of the vehicle by, for example using RLS, the vehicle may also determine a current GNSS based location of the vehicle at 1912. This may either be done prior to, after, and/or simultaneously with the determination of the absolute location of a vehicle using a localization system, e.g., RLS. For example, as described previously, a GNSS receiver may receive a plurality of signals from a corresponding number of satellites to determine the current GNSS based location of the vehicle. However, due to the various sources of error in the determination of this location, the GNSS location and the determined absolute location of the vehicle may not be the same. Accordingly, the vehicle may determine a GNSS localization error based at least in part on the determined absolute location of the vehicle using RLS and the currently measured GNSS location of the vehicle at 1914. Depending on the particular embodiment, and as described previously above, the GNSS localization error may either correspond to a location offset between the actual absolute location of the vehicle and the GNSS approximated location and/or the GNSS localization error may correspond to determined errors in a position and/or timing signal associated with signals from one or more GNSS satellites that are in communication with a GNSS receiver of the vehicle. In some embodiments, the determined GNSS localization error may optionally be transmitted from the vehicle that has determined the GNSS localization error to one or more other vehicles in a region in the vicinity of the first vehicle and/or a remotely located server at 1916. These other vehicles may either be on the same road segment, or different road segments as the disclosure is not limited in this fashion.

After either determining or receiving a GNSS localization error, a vehicle may continue to measure a GNSS location of the vehicle using a GNSS receiver of the vehicle. As noted above, the GNSS localization error may relatively constant over a predetermined region and/or time and may be applied by either a vehicle that determines the GNSS localization error and/or by a vehicle that receives the GNSS localization error. In either case, the GNSS localization error may correspond to an offset that may simply be combined with a measured GNSS location, corrections that may be applied to one or more GNSS signals received by the vehicle, and/or any other appropriate type of GNSS localization error. In either case, the GNSS localization error may be used to correct the GNSS readings to provide a corrected GNSS location that exhibits an improved accuracy as compared to the uncorrected GNSS location of the vehicle at 1918. This corrected GNSS location may then be used by the vehicle and/or a user of the vehicle for any desired application. For example, as noted previously, certain automatic and/or semi-automatic systems of a vehicle may be operated using a priori information related to an upcoming portion of a road segment the vehicle is about to traverse. Thus, using the more accurate corrected GNSS location, a controller of the vehicle may more appropriately control operation of these one or more vehicle systems based at least in part on the corrected GNSS location at 1920. For instance, by more accurately determining a location of a vehicle relative to one or more upcoming road surface features (e.g. a pot hole, bump, frost heave, etc.) along a path of travel of the vehicle, it may be possible to not only control overall operation of the vehicle, but it may be possible to control specific systems of the vehicle (e.g. active suspension system actuators associated with specific wheels) that are expected to respond to the one or more road surface features based on this improved location information.

In some embodiments, it may be desirable to measure certain types of road surface parameters on a road surface of a road segment, e.g. road surface features, for use in controlling operation of one or more vehicle systems. For example, knowing road surface parameters such as a road surface friction coefficient, traction, and/or road-grip at various locations along a road surface of the road segment may be useful in certain applications. In one such embodiment, this information may be used to help determine appropriate operation of vehicle systems such as operation of an antilock braking system (ABS), appropriate inter-vehicle following distances and/or maximum safe speeds for autonomous vehicle and/or driver assist controllers, and/or any other vehicle systems that may be controlled based at least in part on the measured road surface parameter. However, certain types of road surface parameters, such as the above-noted road surface friction coefficient, traction, and/or road grip may not be measured continuously. Without wishing to be bound by theory, this may be due to these types of measurements being performed during elevated wheel slippage which may occur during acceleration, deceleration, and/or turning of the vehicle. In some embodiments, the amount of measured wheel slippage, a rotational speed of the wheels in view of the wheel diameter and speed of the vehicle, an applied wheel torque, and/or other appropriate considerations may be used to determine the above noted road surface parameters during the occurrence of a wheel slippage event. Accordingly, measurements of these parameters may occur intermittently at a plurality of distinct locations that are separated from one another along a road surface as the vehicle is traveling along the road surface.

The Inventors have recognized the benefits associated with methods and systems that can be used to determine a spatial distribution of a road surface parameter that is measured intermittently at discrete locations along a road surface of a road segment. In some embodiments, a plurality of intermittent discrete measurements of a desired road surface parameter may be associated with corresponding locations of a vehicle, and/or a portion of the vehicle, on a road surface when the parameters were measured. These plurality of intermittent discrete measurements and corresponding locations on the road surface may either be obtained from a single vehicle or a plurality of vehicles depending on the particular embodiment. Regardless of the number of vehicles used to collect the desired road surface parameters, the location of a vehicle during some or all of these intermittent measurements may be determined using any appropriate localization method, including the high accuracy localization methods described herein. These measurements and corresponding locations may be aggregated as described in more detail below to provide a spatial distribution of the road surface parameter on the road surface of the road segment. In some embodiments, this may result in a substantially and/or effectively continuous mapping and/or distribution of the one or more parameters relative to the road surface and may be provided as a digital map of the road surface and/or any other appropriate characterization of the road surface as the disclosure is not limited in this fashion. In some embodiments, this substantially and/or effectively continuous mapping and/or distribution may be on a predetermined size scale sufficient for a desired application.

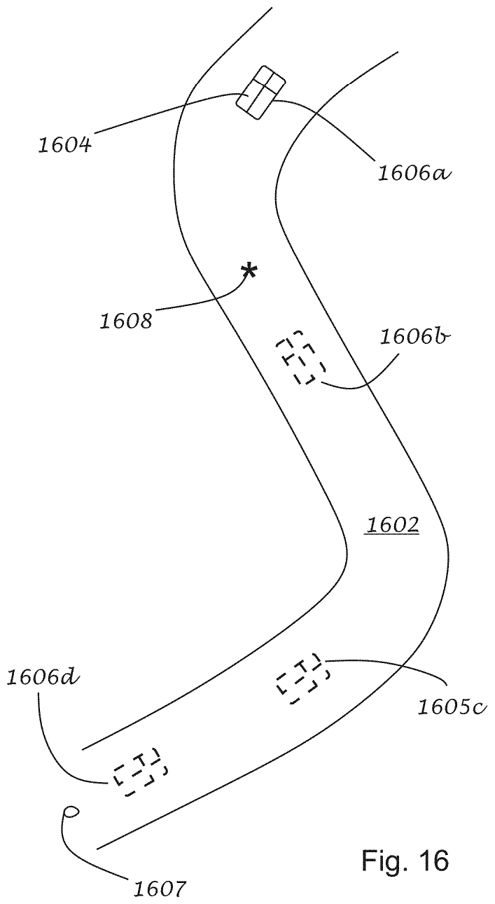

FIG. 16 illustrates a road 1602 where vehicle 1604 measures a road surface parameter, e.g. road friction, friction coefficient, at its current location 1606a and has previously measured that quantity at its previous positions 1606b, 1606c, and 1606d. As discussed earlier, these measurements may not be continuous, but rather discrete measurements.

It should be noted that the location along a road—where a discrete parameter may be measured may not always coincide with a location where accurate location data is available. For example, in FIG. 16 when the vehicle is in location 1606d, sufficiently accurate localization data may not be available. However, prior to when the vehicle is in location 1606d, it may have had an interaction with road surface feature 1607. The location information during the interaction with features 1607 may have been determined to a sufficiently high degree of accuracy, as discussed with regard to vehicle 1102 in FIG. 13. Based on the knowledge of its location during the interaction with feature 1607 and relying on dead-reckoning, the subsequent positions of the vehicle, such as when surface parameters are measured at locations 1606d, 1606c, may be determined and associated with the parameter measurements in the corresponding locations.

Alternatively or additionally, the road surface parameter measurement may be made before the location of the vehicle is determined to a sufficient degree of accuracy. For example, a road surface parameter measurement may be made when the vehicle is in location 1606b when, for example, GNSS error correction may not be available. Relying on dead-reckoning, the vehicle 1604, and/or processors in the Cloud, may then keep track of the vehicle's change in location until it reaches location 1608 where GNSS correction data may become available. Based on GNSS signals at location 1608 and the corrections available at location 1608, and the information about the distance and direction of travel between location 1606b and 1608, the location of the vehicle at 1606b may be accurately determined and associated with the surface parameter measurement at 1606b after the fact.

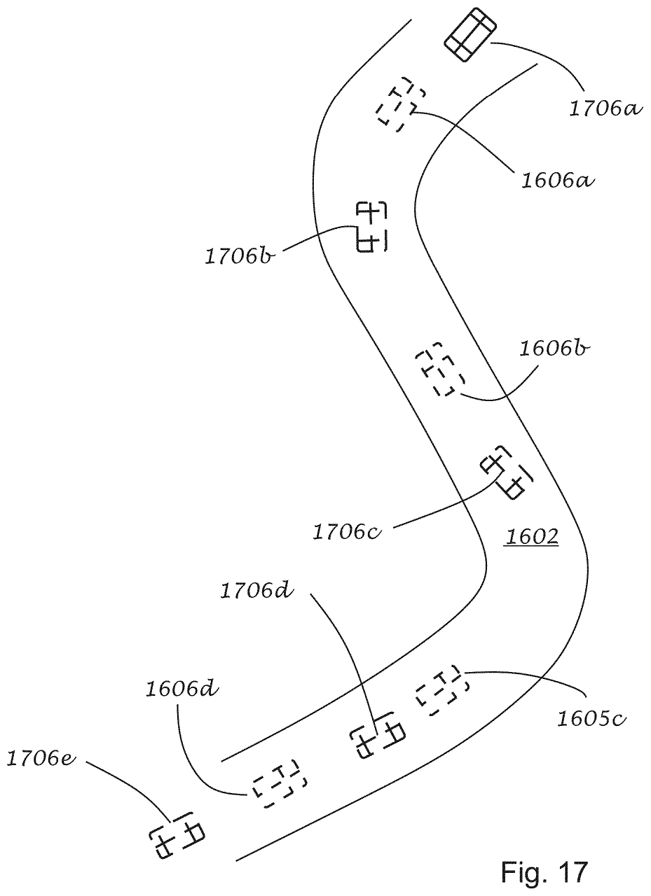

The measurement of each parameter and the location where the measurement was made may be conveyed to a remotely located database (i.e., a remotely located server). This process may be repeated by other vehicles or the same vehicle on subsequent trips along road 1602. For example, FIG. 17 illustrates vehicle 1706, which has made discrete road surface parameter measurements at its current location 1706a and previous positions 1706b, 1706c, 1706d, and 1706e along road 1602 which may not coincide with the measurements by vehicle 1604. Again the location of each of the measurements and the value of the parameter measured may be conveyed to the remote data storage facility. After measurements from multiple trips and/or multiple vehicles, the discrete data may be aggregated to produce a continuous or effectively continuous profile of the measured parameter, such as, for example road surface friction, along road 1602.

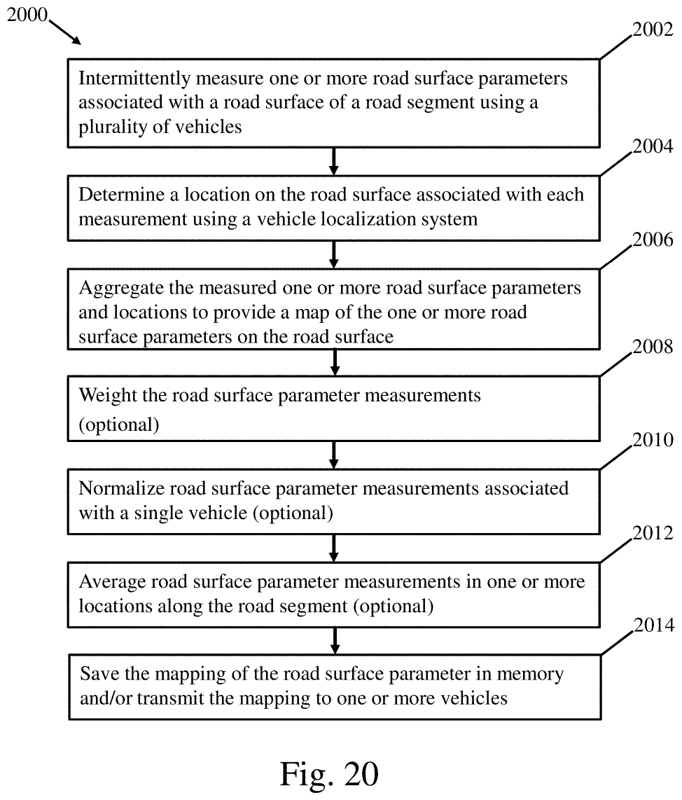

FIG. 20 depicts one embodiment of a method 2000 that may be used to characterize one or more road surface parameters that may be intermittently measured at separate discrete locations along a road surface by a plurality of vehicles and/or a single vehicle on multiple occasions. In some embodiments, portions of the depicted method associated with measuring the one or more road surface parameters may be implemented using one or more processors that are onboard each vehicle used to make the desired measurements. The portions of the depicted method associated with the processing and/or aggregation of the data may be implemented using one or more processors associated with a remotely located server. The various processors may also be associated with corresponding non-transitory computer readable memory that includes processor executable instructions that when executed perform the methods described herein. Of course, it should be understood that the various steps of the disclosed method are not limited to where or how they are implemented as the disclosure is not limited in this fashion.

As shown in the figure, the method 2000 may include intermittently measuring one or more road parameters associated with a road surface of the road segment using a plurality of vehicles and/or a single vehicle on multiple occasions at 2002. For example, while each vehicle is traveling along the road segment, the vehicle may intermittently measure the desired road surface parameter at one or more discrete locations along the road segment. In some embodiments, this may correspond to taking measurements of a road surface parameter when wheel slip occurs as the vehicle traverses the road segment. When the road surface parameter is measured, the vehicle may determine a location on the road surface associated with that particular measurement using any appropriate vehicle localization system at 2004. For example, the vehicle may determine a location of the measurement using: a measured GNSS location; the location of an HAAL landmark as described herein; a corrected GNSS location as described herein; dead reckoning; combinations of the foregoing; and/or any other appropriate localization method as the disclosure is not so limited. For instance, in one specific embodiment, dead reckoning relative to a measured location of the vehicle located either before and/or after a location of a given measurement on the road surface may be used to accurately determine the measurement location. This process of intermittently measuring the one or more road surface parameters and determining associated locations may be conducted for any desired number of times by one or a plurality of vehicles to provide an appropriate level of characterization and accuracy of the one or more road surface parameters along the road surface of the road segment.

Once the desired dataset including road surface parameter measurements and corresponding locations on the road surface is obtained, the dataset may be provided to any appropriate database for further processing. In some embodiments, this may correspond to real time transmission from the vehicles to a remotely located server and/or the data may be downloaded after measurement. In either case, the measured one or more road parameters and locations may be aggregated at 2006 to provide a map, or other characterization, of the one or more road surface parameters on the road surface of the road segment.

In some embodiments, the road surface parameter measurements may be further processed either prior to and/or after aggregation. For example, at 2008 the plurality of road surface parameter measurements may be weighted based on one or more considerations prior to subsequent processing. In one such embodiment, the measurements may be weighted based on a reliability of the surface parameter measurements and/or associated locations. For example, similar to the localization methods described above, road surface parameter measurements and/or locations exhibiting larger errors relative to the other data and/or a previously determined road surface parameter may be given a lower weight as compared to more accurate measurements or excluded from the dataset. Additionally, road surface parameter measurements and/or location information provided by vehicles that have been previously identified as providing less reliable information may also be given lower weights as compared to measurements from the vehicles previously identified as providing accurate measurements.

In some embodiments, it may also be desirable to normalize road parameter measurements that are provided by the same vehicle at 2010. For example, in some embodiments, a road surface parameter may already be characterized at a given location along a road surface at which a measurement of the road surface parameter is measured by the vehicle. By comparing the measured road surface parameter from the current vehicle to the previously determined road surface parameter at that location, data provided by that vehicle may be normalized to provide a more accurate measurement of the road surface parameter. For example, if the measured road surface parameter is different from the actual road surface parameter by a given ratio or absolute offset, the other measurements of the road surface parameter by the same vehicle may be appropriately normalized to improve an accuracy of the overall dataset.

In some instances, multiple measurements of a road surface parameter may be provided for a particular location along a road surface. In such an embodiment, it may be desirable to average the multiple road surface parameter measurements associated with a given location along a road surface at 2012. As noted previously, the average may correspond to a mean, median, and/or mode of the road surface parameter measurements at a given location. In some embodiments, the average may be a running average that is updated using more current measurements as the disclosure is not limited to the type of average. The distribution of the separate locations along a road surface may also correspond to any appropriate size scale as the disclosure is not limited in this fashion. For example, the location distribution (i.e., size scale) of the measured road surface parameter along a road surface may correspond to an accuracy of a localization system used to determine a location of the road surface parameter measurements on the road surface and/or any other appropriate size scale.

After appropriately aggregating and determining the one or more road surface parameters associated with various locations distributed across a road surface of the road segment, the resulting map of the one or more road surface parameters on a road segment may be used for any desired application. For example, the map, or other characterization of the one or more road surface parameters, may be saved to an associated non-transitory computer readable memory for subsequent recall and/or it may be transmitted to one or more vehicles for subsequent usage in controlling one or more automatic and/or semi-automatic systems of the vehicles at 2014. Regardless of the specific application, the resulting aggregated mapping of the intermittent discrete measurements of the road surface parameters may provide continuous or an effectively continuous spatial distribution of the road surface parameter on the road surface of the road-segment. This characterization may also be done without the use of expensive time-consuming road dedicated characterization systems that may not be easily deployed on every road.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology, may operate according to any suitable protocol, and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different from what is illustrated here, which may include performing some acts simultaneously, even though shown as sequential acts in illustrative embodiments.

Further, some actions are described as taken by a “user”. It should be appreciated that a “user” need not be a single individual, and that in some embodiments, actions attributable to a “user” may be performed by a team of individuals and/or an individual in combination with computer-assisted tools or other mechanisms and/or by a virtual user in the form of a computing device.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of correcting a localization error of a vehicle traveling along a road segment, the method comprising:
interacting with a landmark associated with the road segment with the vehicle;
determining a location of the landmark;
determining a Global Navigation Satellite System (GNSS) location of the vehicle; and
determining a GNSS localization error based at least in part on the location of the landmark and the GNSS location of the vehicle.

2. The method of claim 1, further comprising correcting the GNSS location based at least in part on the GNSS localization error.

3. The method of claim 2, further comprising controlling one or more systems of the vehicle based at least in part on the corrected GNSS location.

4. The method of claim 3, wherein the one or more systems of the vehicle includes at least one selected from a suspension system, propulsion system, adaptive driver assistance systems (ADAS), electric power steering system (EPS), a cruise control system, and antilock braking system.

5. The method of claim 1, wherein determining the GNSS location of the vehicle includes receiving GNSS data from multiple satellites with a GNSS receiver on board the first vehicle, and determining the GNSS location based at least in part on the received GNSS data.

6. The method of claim 5, wherein determining the GNSS localization error includes determining an error in the GNSS data.

7. The method of claim 5, wherein the GNSS localization error is specific to one or more of the multiple satellites.

8. The method of claim 7, wherein the error specific to one or more of the multiple satellites is at least one selected from the group of a satellite timing error and a satellite distance error.

9. The method of claim 5, wherein the GNSS satellites are GPS satellites.

10-29. (canceled)

30. A method of determining an absolute location of a landmark associated with a road segment, the method comprising:
obtaining a plurality of estimated locations of the landmark, wherein each estimated location of the landmark is based at least in part on an estimated location of a vehicle when the vehicle interacts with the landmark; and
averaging at least a first portion of the plurality of estimated locations of the landmark to determine the absolute location of the landmark.

31. The method of claim 30, wherein the plurality of estimated locations of the landmark are from a plurality of vehicles.

32. The method of claim 30, wherein the estimated landmark locations are obtained using a localization system and Global Navigation Satellite System receiver onboard each vehicle.

33. The method of claim 30, wherein the landmark is a roadside landmark.

34. The method of claim 33, wherein the roadside landmark is at least one selected from a group consisting of a bridge, a building, a tree, and a road sign.

35. The method of claim 30, wherein the landmark is a subsurface feature.

36. The method of claim 35, wherein the subsurface feature is at least one selected from a group consisting of a buried pipe, a cavity, and a boulder.

37. The method of claim 30, wherein the landmark is a road surface landmark.

38. The method of claim 37, wherein the road surface landmark is at least one selected from a group consisting of a pothole, a bump, a surface crack, an expansion joint, a frost heave, a rough patch, a rumble strip, and a storm grate.

39-58. (canceled)

59. A method of determining an absolute location of a feature associated with a road segment, the method comprising:
(a) on multiple occasions, determining that each of a plurality of vehicles is located at the feature;
(b) on each occasion in (a), determining an estimated absolute location of each of the multiplicity of vehicles by using an onboard GNSS receiver; and
(c) determining the absolute location of the feature based at least partially on an average of at least a subset of the estimated absolute locations determined in (b).

60. The method of claim 59, wherein the estimated absolute location of each vehicle during each interaction is determined based on an output from a GNSS receiver on-board each vehicle.

61-89. (canceled)
